(19) United States
(12) Patent Application Publication
(10) Pub. No.: US 2015/0303988 A1
(43) Pub. Date: Oct. 22, 2015

(54) EFFICIENT GENERATION OF SPREADING SEQUENCE CORRELATIONS USING LOOKUP TABLES

(71) Applicant: TELEFONAKTIEBOLAGET L M ERICSSON (PUBL), Stockholm (SE)

(72) Inventors: Niklas Johansson, Sunnyvale, CA (US); Yi-Pin Eric Wang, Fremont, CA (US); Stephen Grant, Pleasanton, CA (US); Ning He, Sollentuna (SE); Michael Samuel Bebawy, Santa Clara, CA (US)

(21) Appl. No.: 14/442,810

(22) PCT Filed: Nov. 16, 2012
(86) PCT No.: PCT/SE2012/051267

§ 371 Date: May 14, 2015

(51) Int. Cl. H04B 1/709

(52) U.S. Cl. CPC H04B 1/709

(57) ABSTRACT

A signal is received containing a block of multiple symbols, each symbol containing information bits spread by a spreading sequence of chips. Each spreading sequence is determined by a channelization sequence and a first or second complex-valued scrambling sequence of chips. Each block is processed using a set of spreading sequences using correlations between pairs of spreading sequences in the set. Spreading sequence correlation values between each pair are manipulated and stored in lookup tables. A lookup table address is determined using a first set of reduced basic scrambling bits to retrieve correlation values. The first set of reduced basic scrambling bits is based on manipulation of one set of the basic scrambling bits that reduces a number of bits included in the determined address to less than a number of binary values in the one set of basic scrambling bits. The one set of basic scrambling bits is used to construct one of the first and second complex-valued scrambling sequences. The retrieved correlation values may be used in mitigating spreading sequence correlation interference between spreading sequences in the set.

### TECHNICAL FIELD

The technology relates to communications, and in particular, to receiving and detecting multiple symbols transmitted using spreading codes.

### BACKGROUND

For code division multiple access (CDMA) systems where spreading codes or sequences are used to separate data symbols from each other, from control channels and from symbols to/from other users, advanced non-linear receivers using joint detection, such as sphere decoders, assisted maximum likelihood detection (AMLD), multi-stage group detection (MSGD) etc., or symbol-level interference cancellation (IC) require the computation of spreading code correlations to achieve better performance than linear receivers. However, for wideband CDMA (WCDMA) and similar systems, the spreading sequence correlations are symbol-dependent since the scrambling sequence is symbol-dependent. For example, two spreading sequences of spreading factor 16 have one set of correlation values for one symbol period, but another set of correlation values for the next symbol period. Because the correlations change from symbol to symbol, online correlation computation is very demanding. Moreover, the scrambling codes are often long, e.g., for a WCDMA system 10 milliseconds (or 38400 chips long), which also means that precomputed correlations of the spreading sequences require large amounts of memory to store such large number of correlations.

What is needed then is an efficient way to store and provide spreading sequence correlations.

### SUMMARY

Apparatus receives a signal containing a block of multiple symbols, each symbol containing information bits spread by a spreading sequence of chips. Each spreading sequence is determined by a channelization sequence and a first complex-valued scrambling sequence of chips or a second complex-valued scrambling sequence of chips. Correlation circuitry processes each block using a set of multiple spreading sequences using one or more correlations between one or more pairs of spreading sequences in the set. Spreading sequence correlation values between each pair of the multiple spreading sequences in the set are manipulated and stored in one or more lookup tables. An address generator addresses one of the lookup tables with an address determined using a first set of reduced basic scrambling bits to retrieve one or more correlation values from the addressed lookup table. The first set of reduced basic scrambling bits is based on manipulation of one set of the basic scrambling bits that reduces a number of bits included in the determined address to less than a number of binary values in the one set of basic scrambling bits. The one set of basic scrambling bits is used to construct one of the first and second complex-valued scrambling sequences. Symbol estimation circuitry uses the retrieved one or more correlation values in mitigating spreading sequence correlation interference between spreading sequences in the set in a process to detect symbol values for two or more information symbols in the received block. In one example embodiment, the one set of the basic scrambling bits is the one set of scrambling generation bits. In another example embodiment, the one set of the basic scrambling bits is expressed as the one scrambling sequence. Without loss of generality, the one scrambling sequence or the one set of the basic scrambling bits are used as examples.

In preferred example embodiments, manipulation of the one scrambling sequence includes exploiting one or more redundancies of the one scrambling sequence. In one example embodiment, the manipulation includes eliminating at least one bit in a row address for addressing the one lookup table based on a redundant bit value in the one scrambling sequence. In another example embodiment, the manipulation includes storing only one correlation value for two different correlations between each pair of the multiple spreading sequences. In yet another example embodiment, the manipulation includes storing rows in the lookup table only where a first bit in each of two of the first set of basic scrambling bits is equal to 0 in a 0/1 representation of binary bits.

In an example implementation, each complex-valued scrambling sequence is determined by a first binary-valued scrambling sequence that determines a real part of the complex-valued scrambling sequence and a second binary-valued scrambling sequence that determines an imaginary part of the complex-valued scrambling sequence. A code generator generates the first and second binary-valued scrambling sequences for the first complex-valued scrambling sequence. A scrambling bits processor determines the first set of the address bits based on the first and second binary-valued scrambling sequences for the first complex-valued scrambling sequence.

In one variation, the address includes a first set of address bits and a second set of address bits. The code generator generates the first and second binary-valued scrambling sequences for the second complex-valued scrambling sequence. The scrambling bits processor determines a second set of address bits based on the first and second binary-valued scrambling sequences for the second complex-valued scrambling sequence. The one lookup table is addressed with an address determined using the first set of address bits and the second set of the address bits to retrieve a first set of correlation values associated with the spreading sequences of the two or more information symbols.

In example embodiments, mapping circuitry maps the first set of correlation values to an actual correlation value.

In example embodiments, determining the first set of address bits includes using an anchor bit among the first set of the basic scrambling bits to obtain an exclusive-OR (XOR) product with each of the other bits among the first set of the basic scrambling bits and forming the first set of address bits based on the XOR products.

In example embodiments, the first set of address bits represents a number that is greater than or equal to the number represented by the second set of address bits.

In example embodiments, the one lookup table is addressed using the first set of the address bits to retrieve a second set of correlation values associated with the spreading sequences of the two or more information symbols. A detected symbol value for each of the two or more information symbols is based on the second set of correlation values.

In some example embodiments, the complex-valued scrambling sequence is defined by:

C_{long,n}(i)=c_{long,1,n}(i)(1+j(−1)ⁱc_{long,2,n}(2└i/2┘))

wherein:

i is a chip index starting at 0,

the block is a 4-chip symbol block,

the binary values of the scrambling sequence are eight binary values based on the binary values c_{long,1,n}(0), c_{long,2,n}(0), c_{long,1,n}(1), c_{long,2,n}(1), c_{long,1,n}(2), c_{long,2,n}(2), c_{long,1,n}(3), c_{long,2,n}(3) and correspond in this example to the one set of basic scrambling bits, and

c_{long,1,n}(0), c_{long,2,n}(0), c_{long,1,n}(1), c_{long,1,n}(2), c_{long,2,n}(2), c_{long,1,n}(3) correspond in this example to the reduced basic scrambling bits.

### BRIEF DESCRIPTION OF THE DRAWINGS

FIG. 1 illustrates a non-limiting example of a WCDMA channelization code tree from 3GPP TS 25.213;

FIG. 2 illustrates a non-limiting example radio receiver that uses spreading sequence correlations;

FIG. 3 illustrates how different data symbols and control symbols are spread with particular spreading sequences;

FIG. 4 illustrates two 4-chip blocks for which spreading sequence correlations in a non-limiting example are calculated;

FIG. 5 shows an original lookup table for a specific non-limiting detailed spreading sequence correlation example;

FIG. 6 shows a first technique for reducing size of lookup table and a number of lookup table address bits in accordance with a non-limiting example embodiment;

FIG. 7 shows a second technique for further reducing size of a reduced-size lookup table and a number of lookup table address bits in accordance with another non-limiting example embodiment;

FIG. 8 shows a third technique for reducing a number of bits to be stored in a lookup table in accordance with a non-limiting example embodiment;

FIG. 9 illustrates a non-limiting example radio receiver that uses a processor with a specific non-limiting example scrambling sequence;

FIG. 10 illustrates a non-limiting example radio receiver that uses a processor with a specific non-limiting example scrambling generation bits;

FIG. 11 is a portion of a radio receiver that provides spreading sequence correlations in accordance with a non-limiting example embodiment;

FIG. 12 is a portion of a radio receiver that provides spreading sequence correlations in accordance with another non-limiting example embodiment;

FIG. 13 is a non-limiting example of an uplink long scrambling sequence generator;

FIG. 14 is a flowchart of non-limiting example procedures for generating and using correlation values;

FIG. 15 is a function block diagram of a multicode detector that may be used for example in the radio receiver of FIG. 2 in accordance with a non-limiting example embodiment;

FIG. 16 shows a non-limiting example embodiment that uses multiple spreading sequence correlation lookup tables;

FIG. 17 shows a non-limiting example embodiment that uses multiple spreading sequence correlation lookup tables and optional correlation mappers;

FIG. 18 shows a non-limiting example embodiment with one spreading sequence correlation lookup table and multiple optional correlation mappers;

FIG. 19 shows a non-limiting example of a spreading sequence correlation lookup table output used by an optional correlation mapper;

FIG. 20 shows a non-limiting example embodiment with a spreading sequence correlation lookup table with correlation post-processing; and

FIG. 21 shows another non-limiting example embodiment of a spreading sequence correlation lookup table.

### DETAILED DESCRIPTION

The following description sets forth specific details, such as particular embodiments for purposes of explanation and not limitation. But it will be appreciated by one skilled in the art that other embodiments may be employed apart from these specific details. In some instances, detailed descriptions of well known methods, nodes, interfaces, circuits, and devices are omitted so as not to obscure the description with unnecessary detail. Those skilled in the art will appreciate that the functions described may be implemented in one or more nodes using hardware circuitry (e.g., analog and/or discrete logic gates interconnected to perform a specialized function, ASICs, PLAs, etc.) and/or using software programs and data in conjunction with one or more digital microprocessors or general purpose computers. Nodes that communicate using the air interface also have suitable radio communications circuitry. Moreover, the technology can additionally be embodied within any form of non-transitory, computer-readable memory, such as solid-state memory, magnetic disk, or optical disk containing an appropriate set of computer instructions that would cause one or more processors to carry out the techniques described herein.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be implemented by computer program instructions that may be stored in a non-transitory, computer-readable storage medium and which when executed by one or more computers or processors cause the processes to be performed, whether or not such computer(s) or processor(s) is(are) explicitly shown.

Hardware implementation may include or encompass, without limitation, digital signal processor (DSP) hardware, a reduced instruction set processor, hardware (e.g., digital or analog) circuitry including but not limited to application specific integrated circuit(s) (ASIC) and/or field programmable gate array(s) (FPGA(s)), and (where appropriate) state machines capable of performing such functions.

In terms of computer implementation, a computer is generally understood to comprise one or more processors or one or more controllers, and the terms computer, processor, and controller may be employed interchangeably. When provided by a computer, processor, or controller, the functions may be provided by a single dedicated computer or processor or controller, by a single shared computer or processor or controller, or by a plurality of individual computers or processors or controllers, some of which may be shared or distributed. Moreover, the term “processor” or “controller” also refers to other hardware capable of performing such functions and/or executing software, such as the example hardware recited above.

The functions of the various elements including functional blocks, including but not limited to those labeled or described as a computer, processor, or controller, may be provided through the use of hardware such as circuit hardware and/or hardware capable of executing software in the form of coded instructions stored on non-transitory, computer-readable medium. Thus, such functions and illustrated functional blocks are to be understood as being either hardware-implemented and/or computer-implemented, and thus machine-implemented.

The technology provides a structure associated with a set of scrambling sequences or sets of scrambling generation bits together with one or more pre-computed lookup tables to quickly obtain correlations (including auto-correlations and cross-correlations) between the spreading sequences. The technology is less computationally demanding than pre-computing and storing all possible correlations and requires only a relatively small memory. The one or more pre-computed lookup tables are stored in a memory accessible by a receiver. When the receiver receives and processes a received signal, certain basic scrambling bits (which are binary representations of the scrambling sequence or of the scrambling generation bits that generate the scrambling sequence) are used to generate an address to identify appropriate lookup table locations of the one or more lookup tables to access and retrieve desired pre-computed correlation values. Correlation values retrieved from a lookup table may be used either directly as the desired correlation, or as an index into one or more other lookup tables to obtain the desired correlation. The correlation values stored in the one or more lookup tables include cross-correlations of different time-lags between any pair of spreading sequences within a set of spreading sequences. The same table may be used to store cross-correlations of all the sequence pairs. Alternatively, a separate table may be used for each sequence pair. Ultimately, the receiver may use the obtained correlations for joint detection or other receiver processing. The following example description is in the example and non-limiting context of joint detection, but those skilled in the art understand that the technology is not limited thereto and has other applications.

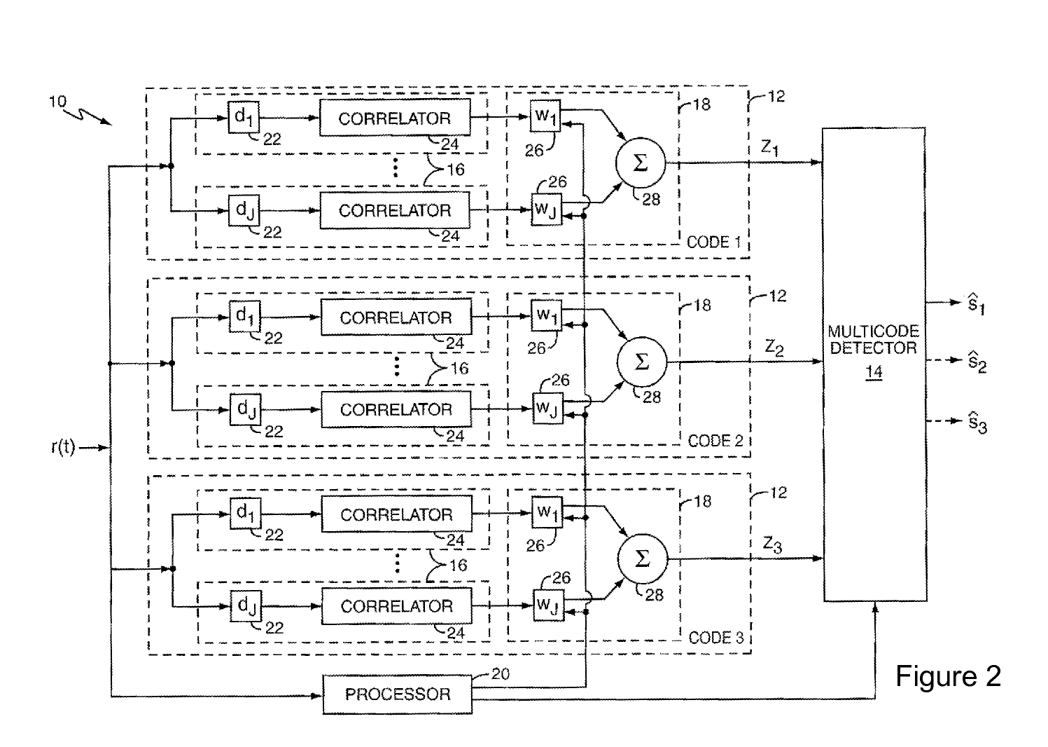

FIG. 2 illustrates a block diagram of a non-limiting example multi-code receiver 10 according to one embodiment for jointly detecting signals in a composite received signal transmitted on different spreading sequences. The receiver 10 comprises a RAKE receiver 12 for each sequence to despread the composite received signal and to generate combined values corresponding to each spreading sequence, and a multi-code detector 14 for jointly detecting symbols transmitted on the code channels of interest. The RAKE receiver 12 may comprise a conventional RAKE receiver or a generalized RAKE (G-RAKE) receiver. The multi-code detector 14 may comprise a linear Minimum Mean Squared Error (MMSE) detector or maximum likelihood (ML) joint symbol detector. The example embodiment of the receiver 10 may be configured for a High Speed Packet Access (HSPA) mode, either downlink or uplink, in a WCDMA system and may be used in a base station or a mobile terminal.

Each RAKE receiver 12 comprises a plurality of RAKE fingers 16, a plurality of RAKE combiners 18, and a RAKE processor 20. Each RAKE finger 16 processes different time shifts or multi-path echoes of the received signal r(t). Typically, each RAKE finger 16 comprises a delay element 22 and a correlator or despreader 24. Delay elements 22 delay the received signal r(t) to time align the multi-path echoes processed by each RAKE finger 16. Correlators 24 correlate the delayed signals with a spreading sequence to extract the assigned multi-path echoes from the received signal r(t). Despread values from correlators 24 are combined in combiner 18. Combiner 18 typically includes weighting elements 26 and summer 28. Weighting elements 26 weight the multi-path echoes output from respective correlators 24. The weighted multi-path echoes are summed symbol-by-symbol by summer 28 to form a RAKE combined value during each symbol period. Those skilled in the art appreciate that the combining weights associated with weighting elements 26 may correspond to the conjugates of the multiplying coefficients of the multi-path echoes (RAKE) or conjugates of weights that depend on the coefficients and a noise and interference correlation matrix (G-RAKE). The combining weights are computed by the processor 20. Each RAKE combined value represents a symbol of interest or an interfering symbol. Importantly, symbols of interest also interfere with one another. In other words, when a given symbol of interest is considered, the other symbols of interest may be considered as interfering symbols. Further details of the example receiver 10 may be found in commonly-assigned, U.S. patent application publication US 2008/0267265, the contents of which are incorporated herein by reference.

So joint detection uses the correlations of the involved spreading sequences, but the correlations change with each joint detection block because the scrambling sequence for each spreading sequence changes. The following description explains how to precompute and efficiently store and access the sequence correlations needed for joint detection of 4-chip symbol blocks in a wideband code division multiple access (WCDMA) radio communication system context. But the technology is not limited to 4-chip symbol blocks or to WCDMA systems, but instead may be used in any system where sequence correlation values are stored and accessed.

For example, in WCDMA Enhanced Uplink (EUL), long scrambling codes are often used. Because they repeat only after 10 milliseconds (or 38400 chips), a large amount of memory is needed to store precomputed sequence correlations for every 4-chip block directly. To overcome this problem, the inventors identified certain scrambling sequence generation properties and exploited those properties to reduce the storage space needed to store spreading sequence correlations so that all spreading sequence correlations between any 4-chip symbol blocks can be stored in less than 10 kbytes of memory, if desired. Furthermore, if only the correlations of the spreading sequences within one 4-chip symbol block are needed, then only 512 bytes of memory or less is needed for the lookup table, if desired.

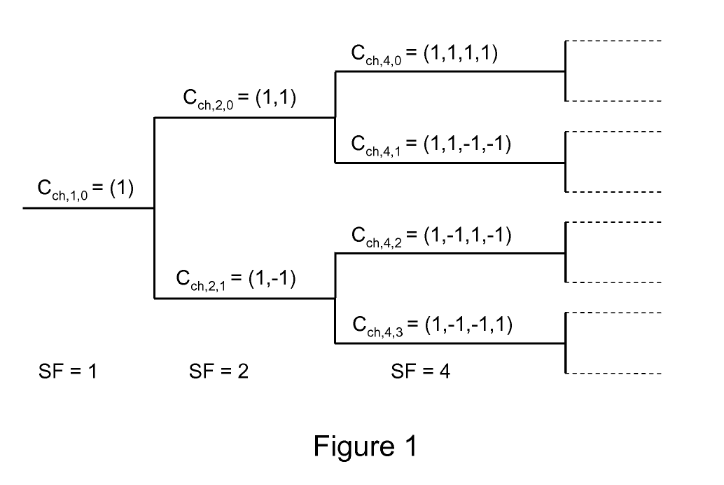

WCDMA spreading codes include orthogonal channelization sequences that are scrambled with a complex-valued scrambling sequence. For an EUL peak rate, the channelization sequences used are C_{ch,2,1} and C_{ch,4,1}, and the control channels use sub-branches of the C_{ch,4,0} channelization code tree as shown in FIG. 1 and described in 3GPP TS 25.213. A QPSK scrambling sequence is comprised of a number of chips, each of which may take values 1+j, 1−j, −1+j, and −1−j, where j²=−1. Thus, a QPSK scrambling sequence of length 4-chips has the form (u₁+jv₁, u₂+jv₂, u₃+jv₃, and u₄+jv₄), where each uᵢ and vᵢ, may take the value +1 or −1. So in general, 8 binary values, or bits, may be used to represent a 4-chip long QPSK scrambling sequence.

However, the complex-valued long scrambling code used in WCDMA UL as specified in 3GPP TS 25.213, section 4.3.2 has the form:

C_{long,l}(i)=c_{long,1,l}(i)(1+j(−1)ⁱc_{long,2,l}(2└i/2┘)) (1)

where l is the long scrambling code number, └ ┘ denotes rounding to the nearest lower integer, and where c_{long,1,l}(i) and c_{long,2,l}(i) are binary-valued scrambling sequences taking values {+1, −1}. Each individual scrambling chip is defined by two bits: the values of c_{long,1,l}(i) and c_{long,2,l} (2└i/2┘) (with an index i). However, the inventors observed that since the same c_{long,2,l}(i) value is used for two consecutive scrambling chips, (indexes i=2k and i=2k+1, where k is an integer), the value of a pair of scrambling chips C_{long,l}(2*k) and C_{long,l}(2*k+1) is completely determined by only three bits, i.e., the values c_{long,1,l}(2*k), c_{long,1,l}(2*k+1), and c_{long,2,l}(2*k). As a result, the scrambling sequence in a block of four chips is completely determined by 6 bits, in contrast to the 8 bits required to represent a general QPSK scrambling sequence lacking the special structure in equation (1). The real and imaginary parts of the chips of the scrambling code described by equation (1) can be separately expressed as:

real(C_{long,l}(i))=c_{long,1,l}(i) (1a)

imag(C_{long,l}(i))=(−1)ⁱc_{long,1,l}(i)c_{long,2,l}(2└i/2┘) (1b)

and, thus, c_{long,1,l}(2*k), c_{long,1,l}(2*k+1), and c_{long,2,l}(2*k) can be expressed as functions of real(C_{long,l} (i)) and imag(C_{long,l}(i)):

c_{long,1,l}(2k)=real(C_{long,l}(2k)) (1c)

c_{long,1,l}(2k+1)=real(C_{long,l}(2k+1)) (1d)

c_{long,2,l}(2k)=imag(C_{long,l}(2k)/real(C_{long,l}(2k)) (1e)

This way, the value of a pair of scrambling chips C_{long,l}(2*k) and C_{long,l}(2*k+1) can also be described as completely determined by the real and imaginary part of C_{long,l}(2*k) and the real part of C_{long,l}(2*k+1). The imaginary part of C_{long,l}(2*k+1) is determined by the real and imaginary parts of C_{long,l}(2*k) and the real part of C_{long,l}(2*k+1) as:

imag(C_{long,l}(2k+1))=real(C_{long,l}(2k+1))imag(C_{long,l}(2k))/real(C_{long,l}(2k)) (1f).

So in a pair of scrambling chips, only the real and imaginary part of the first chip (2 bits) together with the real part of the second chip (1 bit) are required to completely determine the values of the chip pair. A benefit from this technique is that only 6 bits are required to determine the scrambling sequence in a block of 4 chips. Although UL short scrambling sequences are much shorter than the long sequences, i.e., only 256 chips, both long and short scrambling sequences benefit from the technology described in this application.

In WCDMA, symbols are spread with spreading sequences that are composed of channelization sequences and scrambling sequences. A spreading sequence may be expressed as:

S_{SF,k}(i)=C_{ch,SF,k}(i)*C_{long,l}(i) (2)

where C_{ch,SF,k}(i) is a channelization sequence k of spreading factor SF, and S_{SF,k}(i) is the corresponding spreading sequence k of spreading factor SF, and i is the chip index.

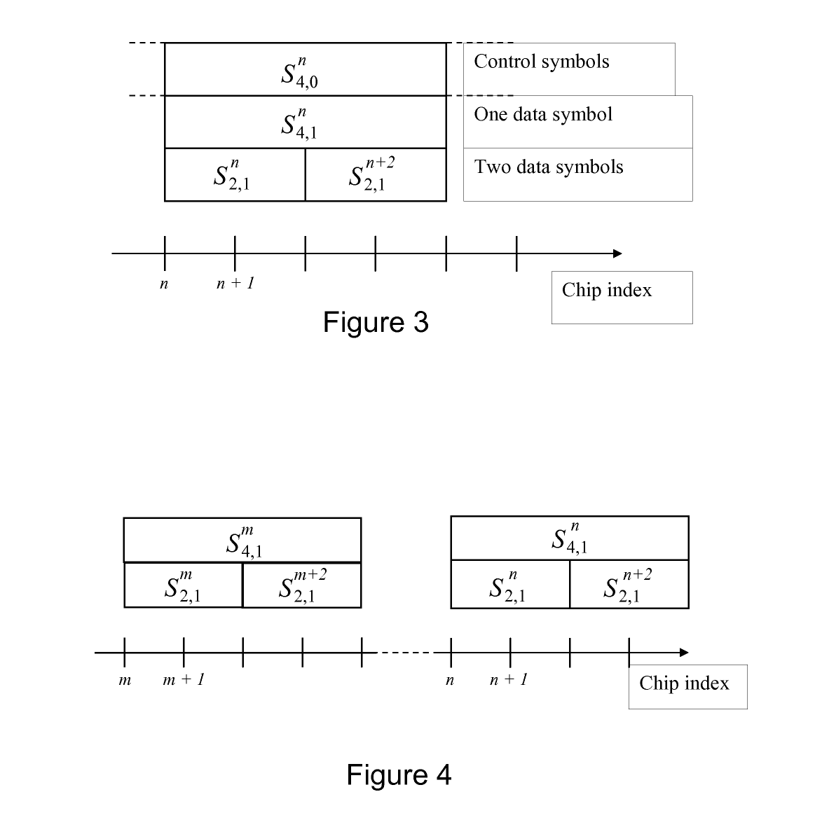

The spreading sequences of spreading factor 2 and 4 used in a 4-chip block include: S_{4,1} and S_{2,1} for data, and S_{4,0} (which is the root for control channel spreading sequences of spreading factors higher than 4) for control information, where n here denotes the chip index of the first chip of the spreading sequence. FIG. 3 illustrates how SF2 and SF4 data symbols and SF>4 control symbols are spread with spreading sequences S_{2,1}ⁿ, S_{2,1}ⁿ⁺², S_{4,1}ⁿ and sub-branches of S_{4,0}ⁿ in a 4-chip symbol block. The data symbols in one or more symbol blocks may be jointly detected to alleviate the inter-symbol interference (ISI) among them. Since the ISI between two symbols is characterized by the cross-correlations between their spreading sequences, spreading sequence cross-correlations are essential for the receiver to perform joint detection.

Expressed as row vectors, the data spreading sequences are:

S_{2,1}ⁿ=[S_{2,1}(n)S_{2,1}(n+1)]

S_{2,1}ⁿ⁺²=[S_{2,1}(n+2)S_{2,1}(n+3)]

S_{4,1}ⁿ=[S_{4,1}(n)S_{4,1}(n+1)S_{4,1}(n+2)S_{4,1}(n+3)]

where n=4*k and k is an integer.

To make the calculations in 4-chip blocks easier to follow, the spreading sequences of spreading factor 2 may be expressed as being of spreading factor 4 but with zeros inserted:

S_{2,1}ⁿ=[S_{2,1}(n)S_{2,1}(n+1)0 0]

S_{2,1}ⁿ⁺²=[0 0S_{2,1}(n+2)S_{2,1}(n+3)]

The value of the SF4 data spreading sequence S_{4,1}ⁿ is completely determined by channelization sequence C_{ch,4,1} and the 6 bits c_{long,1,l}(n), c_{long,1,l}(n+1), c_{long,1,l}(n+2), c_{long,1,l}(n+3), c_{long,2,l}(n) and c_{long 2,l}(n+2) of 8 basic scrambling bits. As will be described in more detail below, this structure is used to manipulate one or more of the scrambling sequences in a way that reduces a number of bits in constructing one of the example lookup tables that store spreading sequence correlation values and in an address used to address the lookup table. Significantly, the reduced number of bits included in the address is less than a number of binary values in the scrambling sequence.

Similarly, for the SF2 data spreading sequences, the values of the spreading sequence are determined by the channelization code C_{ch,2,1} and by 3 bits of 4 basic scrambling bits. S_{2,1}ⁿ is determined by c_{long,1,l}(n), c_{long,1,l}(n+1), and c_{long,2,l}(n), S_{2,1}²⁺² is determined by c_{long,1,l}(n+2), c_{long,1,l}(n+3), and c_{long,2,l}(n+2).

When multiple symbol blocks are included in joint detection, cross-correlations between spreading sequences from different symbol blocks are needed. The two symbol blocks are denoted by the superscripts m and n. Although the two symbol blocks may correspond to different scrambling sequences and different users, as well as different 4-chip symbol blocks of the signal from the same user, for notational simplicity, it is assumed they correspond to different 4-chip symbol blocks of the same user. FIG. 4 illustrates a pair of 4-chip symbol blocks for which the spreading sequence correlations in the example are calculated.

The spreading sequence correlations are:

$$( {S}_{4 , 1}^{m} * {S}_{4 , 1}^{n} ) ( t ) = {\sum }_{k = max ( 0 , - t )}^{min ( 3 , 3 - t )} {S}_{4 , 1}^{*} ( m + k ) {S}_{4 , 1} ( n + k + t )$$

$$( {S}_{4 , 1}^{m} * {S}_{2 , 1}^{n} ) ( t ) = {\sum }_{k = max ( 0 , - t )}^{min ( 3 , 1 - t )} {S}_{4 , 1}^{*} ( m + k ) {S}_{2 , 1} ( n + k + t )$$

$$( {S}_{4 , 1}^{m} * {S}_{2 , 1}^{n + 2} ) ( t ) = {\sum }_{k = max ( 0 , 2 - t )}^{min ( 3 , 3 - t )} {S}_{4 , 1}^{*} ( m + k ) {S}_{2 , 1} ( n + k + t )$$

$$( {S}_{2 , 1}^{m} * {S}_{2 , 1}^{n} ) ( t ) = {\sum }_{k = max ( 0 , - t )}^{min ( 1 , 1 - t )} {S}_{2 , 1}^{*} ( m + k ) {S}_{2 , 1} ( n + k + t )$$

$$( {S}_{2 , 1}^{m} * {S}_{2 , 1}^{n + 2} ) ( t ) = {\sum }_{k = max ( 0 , 2 - t )}^{min ( 1 , 3 - t )} {S}_{2 , 1}^{*} ( m + k ) {S}_{2 , 1} ( n + k + t )$$

$$( {S}_{2 , 1}^{m + 2} * {S}_{2 , 1}^{n + 2} ) ( t ) = {\sum }_{k = max ( 2 , 2 - t )}^{min ( 3 , 3 - t )} {S}_{2 , 1}^{*} ( m + k ) {S}_{2 , 1} ( n + k + t )$$

and so on. The min and max functions are used to keep the correlation calculations within the spreading sequence length.

The spreading sequence correlations are stored in one or more lookup tables in one or more memories. Although it is understood that the correlations may be stored in a variety of ways in memory, for explanation and illustration purposes only, each row in a lookup table stores the correlation value of two spreading sequences. The number of bits needed for one row, i.e., the memory space needed in this example table configuration, is now examined using the correlation of two SF4 sequences. As shown above, the correlations are sums, and for the spreading sequences of length 4, the correlation values are:

(S_{4,1}^{m}*S_{4,1}ⁿ)(3)=S_{4,1}*(m)S_{4,1}(n+3)

(S_{4,1}^{m}*S_{4,1}ⁿ)(2)=S_{4,1}*(m)S_{4,1}(n+2)+S_{4,1}(m+1)S_{4,1}(n+3)

(S_{4,1}^{m}*S_{4,1}ⁿ)(1)=S_{4,1}*(m)S_{4,1}(n+1)+S_{4,1}*(m+1)S_{4,1}(n+2)+S_{4,1}*(m+2)S_{4,1}(n+3)

(S_{4,1}^{m}*S_{4,1}ⁿ)(0)=S_{4,1}*(m)S_{4,1}(n)+S_{4,1}*(m+1)S_{4,1}(n+1)+S_{4,1}*(m+2)S_{4,1}(n+2)+S_{4,1}*(m+3)S_{4,1}(n+3)

and so on.

Each complex-valued scrambling chip may be understood as a complex symbol with amplitude \sqrt{2} and phase 45 degrees+90*n degrees, (where n is an integer). Since the channelization codes take the values {+1, −1}, a chip of a spreading code can be seen as such a complex symbol. The result of the multiplication of two such chips is a new complex symbol with amplitude 2 and phase 90*n degrees taking the values {+2, +2j, −2, −2j} where j²=−1. So each term in the sum in the correlation expressions can take one of these four values. For (S_{4,1}^{m}*S_{4,1}ⁿ)(−3) and (S_{4,1}^{m}*S_{4,1}ⁿ)(3), there is only one term in the sum, so these correlations can take four values and can thus be represented by 2 bits each.

A sum of two of these terms can take any of 9 unique values {0, +2+2j, +2−2j, −2+2j, −2−2j, +4, +4j, −4, −4j}, so the sum can be represented by 4 bits (4 bits can take 2⁴=16 values). Thus, (S_{4,1}^{m}*S_{4,1}ⁿ)(−2) and (S_{4,1}^{m}*S_{4,1}ⁿ)(2) can be represented by 4 bits each. In the same way, a sum of three terms can take 16 unique values and can be represented by 4 bits, and a sum of four terms can take 25 unique values and can be represented by 5 bits. Thus, the number of bits required to store (S_{4,1}^{m}*S_{4,1}ⁿ)(−3) and (S_{4,1}^{m}*S_{4,1}ⁿ)(3) is 2 bits each, (S_{4,1}^{m}*S_{4,1}ⁿ)(−2), (S_{4,1}^{m}*S_{4,1}ⁿ)(2), (S_{4,1}^{m}*S_{4,1}ⁿ)(−1) and (S_{4,1}^{m}*S_{4,1}ⁿ)(1) is 4 bits each, and (S_{4,1}^{m}*S_{4,1}ⁿ)(0) is 5 bits.

So to store the correlation values of two SF4 spreading codes, a total of 25 bits is required. If a typical lookup table is used, it is more advantageous to use 32 bits, because then each row in the table is 32 bits or 4 bytes offset to the next row to provide simple addressing into such a table. Take the row number (starting from 0) and multiply it by 32 which is readily done by bit-shifting it 5 steps to the left. It is preferred to represent the correlations using 4 bits, except (S_{4,1}^{m}*S_{4,1}ⁿ)(0) which uses 8 bits.

For correlations of one SF4 code with one SF2 code, the correlation values take 4, 9, 9, 9, and 4 unique values for three different correlation lags. This can be represented by 2, 4, 4, 4, and 2 bits, respectively, and a table of these correlations would thus require 16 bits in each row. For correlations of two SF2 codes, the correlation values take 4, 9, and 4 unique values for the three different correlation lags. These values may be represented by 2, 4, and 2 bits so that each row holds 8 bits.

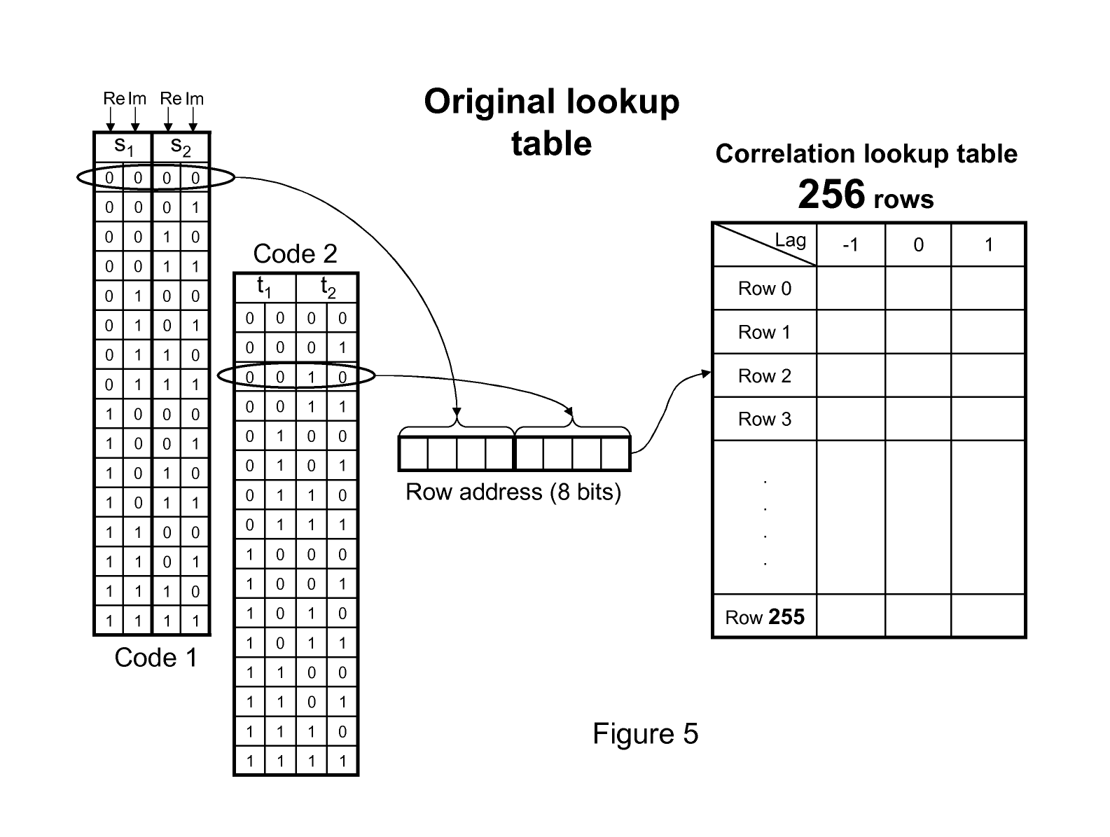

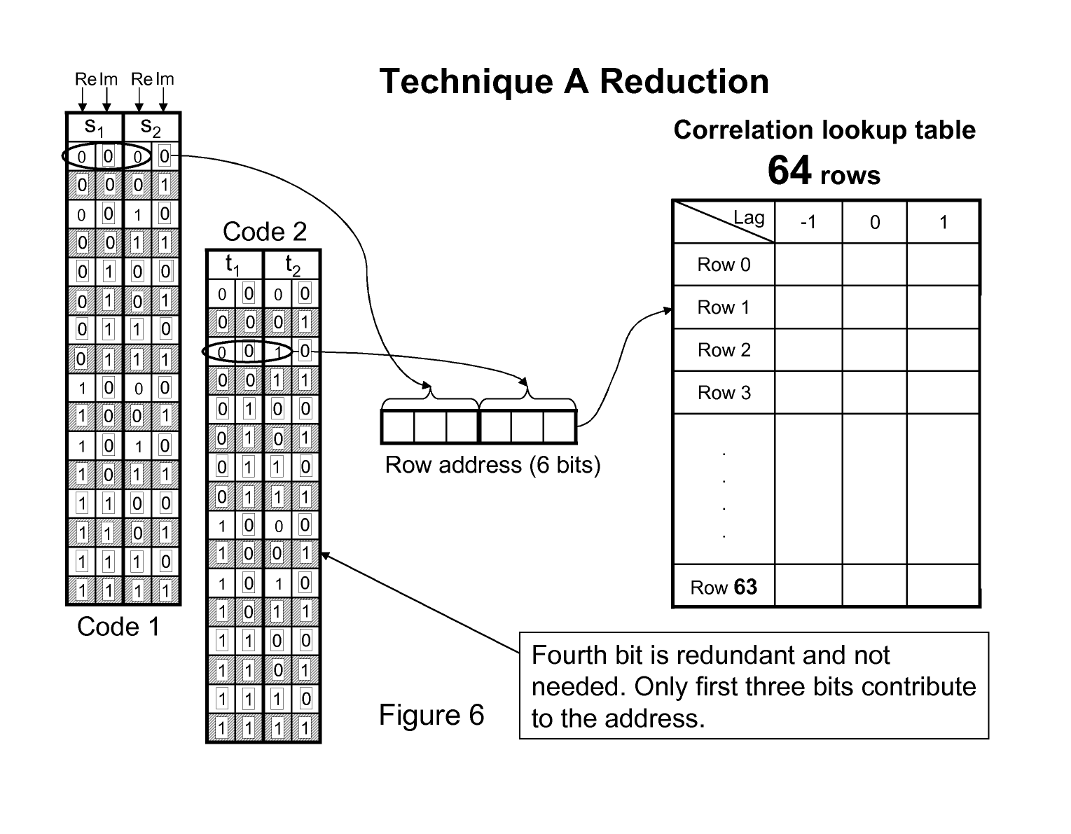

In terms of the number of rows in a lookup table, because 6 bits determine the scrambling of one SF4 spreading code as described above in conjunction with equation (1), a SF4×SF4 table of all correlations of two SF4 spreading codes includes 2⁶⁺⁶=4096 rows. With 32 bits in each row, the table of size is 4096*32 bits=16 kbytes instead of 2⁸⁺⁸=65536 rows×32 bits=256 kbytes. In other words, the storage requirements are reduced 16 times. This simplified table structure is referred to as example technique A. Example technique A is described further below in conjunction with FIGS. 5 and 6.

The following specific examples help illustrate some of the advantageous efficiencies of the technology for example technique A. FIG. 5 shows an original lookup table for a specific non-limiting detailed spreading sequence correlation example with two spreading codes 1 and 2 (the term code is used in this example rather than sequence). Code 1 is represented by s₁ and s₂ which are QPSK symbols in the complex plane, each represented by 2 bits, one bit for the real part and one bit for the imaginary part. So there are 2⁴=16 possible sequences for code 1. Code 2 is represented by t₁ and t₂ which are QPSK symbols, each represented by 2 bits. So there are 2⁴=16 possible sequences for code 2. Each of code 1 and code 2 is represented by 4 bits. The correlation of Code 1 with Code 2 is stored in a lookup table. The number of table rows correspond to the number of possible (Code 1-Code 2) combinations. In this example, 16×16=256 rows. So the row address (RA) is 8 bits (2⁸=256). The first four bits of the row address come from Code 1, and the last four bits come from Code 2. The columns of the lookup table correspond to the different delays or lags at which the correlation is computed. This example shows three columns lags −1, 0, and 1. The lookup table size reduction now described may be done using one or more of three example techniques A, B, and C. The techniques may be used alone or in any combination among them depending on the code structure and/or the implementation.

FIG. 6 shows a first technique for reducing a number of lookup table address bits in accordance with example technique A from a row address size of 8 bits as in FIG. 5 to 6 bits in FIG. 6 by exploiting the characteristics of equation (1). As described above, only the real and imaginary parts of s₁ and the real part of s₂ are required to completely determine the values of Code 1, and the real and imaginary parts of t₁ and the real part of t₂ are required to completely determine the values of Code 2. Hence, the imaginary part of s₂ and t₂ are redundant and not needed. Only the first three bits in the row contribute to the address. So technique A removes the redundant rows with the following scrambling code constraint: Im(s₂)=1, which means there are 8 possible sequences for Code 1 (instead of 16). Therefore, Code 1 only needs 3 bits instead of 4 (i.e., 2³=8). Similarly, removing rows for which Im(t₂)=1 implies that only 8 sequences for Code 2 are needed (instead of 16). Code 2 needs 3 bits only instead of 4. The number of table rows is 8×8=64 rows. Thus, the row address (RA) in this example is 6 bits instead of 8, which means that the lookup table size is reduced to 64/256 or ¼ of its initial size. In more realistic cases, the size reduction is even larger, e.g., 1/16.

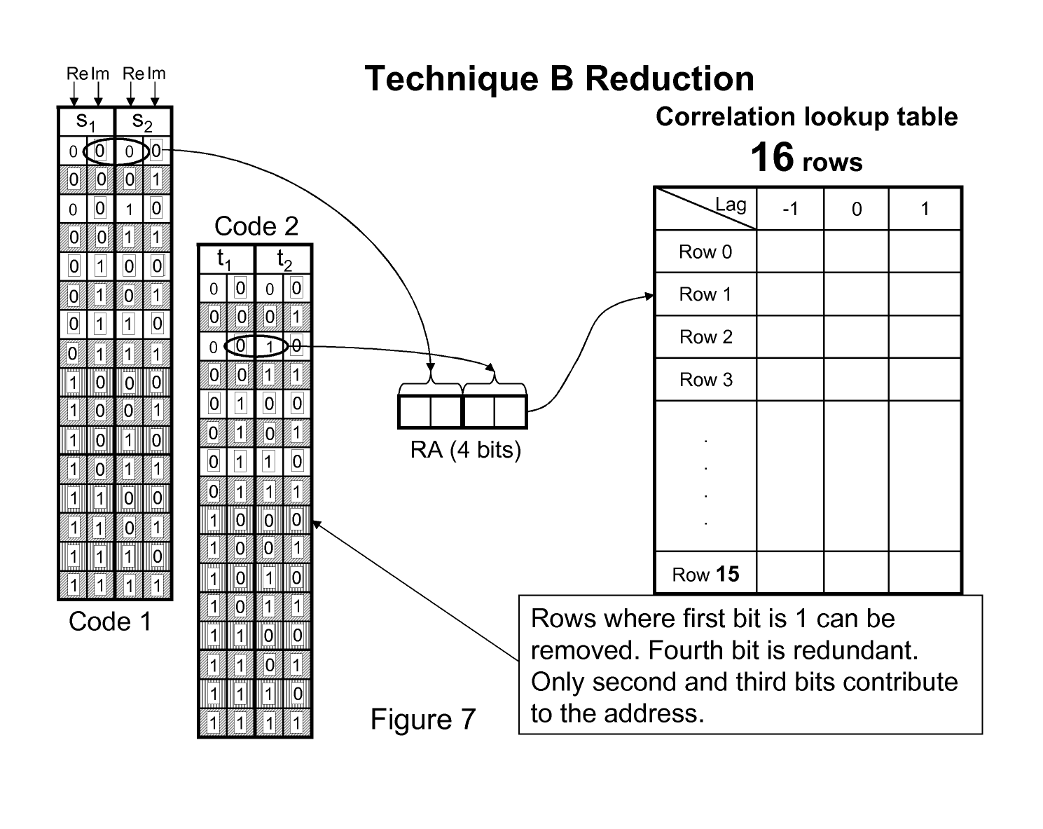

FIG. 7 shows a second technique for further reducing a number of lookup table bits and accordingly address bits in accordance with the non-limiting example technique B. The real part of complex symbols s₁ and t₁ can be ±1 with [1, −1] binary representation or 0/1 with [0, 1] binary representation, and these real parts of s₁ and t₁ are here denoted “anchor bits”. Code 1 is then multiplied by Re(s₁)—this corresponds to an exclusive OR operation if the binary values are 0 and 1 or a multiplication operation if the binary values are +1 and −1, to produce a new set s₁′ and s₂′. Similarly, Code 2 is multiplied by Re(t₁) to produce a new set t₁′ and t₂′. Because Re(s₁′)=+1 and Re(t₁′)=+1, Code 1 is determined by Im(s₁′) and Re(s₂′), which means there are 4 possible sequences for Code 1 (represented by two bits instead of 3). (Note: in a case of using technique B alone, Im(s₂′) is also needed). Similarly, Code 2 is determined by Im(t₁′) and Re(t₂′) with 4 possible sequences for Code 2 (represented by two bits instead of 3).

FIG. 7 shows that for certain row entries, the first bit is always 1, and the fourth bit is redundant as described above. Thus, only the second and third bits contribute to the row address, and the entries where the first bit is 1 can be removed. The number of table rows is 4×4=16 rows, and the row address (RA) is 4 bits. After looking up the table entry (Code 1, Code 2, Lag), the required correlation bits are recovered by multiplying by the product of the “anchor bits” Re(s₁)×Re(t₁). This removes the effect of the earlier imposed exclusive OR operations described above. The technique A and B size reduction for this example is 16/256 or just 6.25% of the original table size. In more realistic cases, the size reduction is even larger.

Another example technique B discovered by the inventors is to include rows only for those cases where the first bit in each of the two scrambling generation sequences is equal to 1 for ±1 representation. For 0/1 representation, the first rows with value 0 are kept. As described above, the 8 scrambling generation bits for the first symbol block of 4 chips in FIG. 4 are determined by 6 of them (c_{long,1,l}(m), c_{long,1,l}(m+1), c_{long,1,l}(M+2), c_{long,1,l}(m+3), c_{long,2,l}(m), c_{long,2,l}(m+2)). Setting the first bit to one produces (1, c_{long,1,l}(m+1), c_{long,1,l}(m+2), c_{long,1,l}(m+3), c_{long,2,l}(m), c_{long,2,l}(m+2)). Setting the first bit of the 6 bits of the 8 scrambling generation bits of the second symbol block of 4 chips to one produces (1, c_{long,1,l}(n+1), c_{long,1,l}(n+2), c_{long,1,l}(n+3), c_{long,2,l}(n), c_{long,2,l}(n+2)) 2̂10=1024 rows are needed. The correlation values with (c_{long,1,l}(m), c_{long,1,l}(m+1), c_{long,1,l}(m+2), c_{long,1,l}(m+3), c_{long,2,l}(m), c_{long,2,l}(m+2)) and (c_{long,1,l}(n), c_{long,1,l}(n+1), c_{long,1,l}(n+2), c_{long,1,l}(n+3), c_{long,2,l}(n), c_{long,2,l}(n+2)) of the first and second chip symbol blocks are identical to those with (1, c_{long,1,l}(m) c_{long,1,l}(m+1), c_{long,1,l}(m) c_{long,1,l}(m+2), c_{long,1,l}(m) c_{long,1,l}(m+3), c_{long,1,l}(m)c_{long,2,l}(m), c_{long,1,l}(m)c_{long,2,l}(m+2)) and (1, c_{long,1,l}(n)c_{long,1,l}(n+1), c_{long,1,l}(n)c_{long,1,l}(n+2), c_{long,1,l}(n)c_{long,1,l}(n+3), c_{long,1,l}(n)c_{long,2,l}(n), c_{long,1,l}(n)c_{long,2,l}(n+2)) multiplied by c_{long,1,l}(m) c_{long,1,l}(n).

For the correlation of two SF2 codes, only 3 of the 4 scrambling generation bits are needed for each code. In total, there will be 2⁶=64 rows in such a SF2×SF2 table, and for the correlation of one SF4 code with one SF2 code, 6+3=9 scrambling generation bits determine that the number of rows in the table will be 2⁹=512. For these correlations, there is less of a need to pack the table more compactly as there might be for the SF4×SF4 table above.

However, one or more of the techniques described above may be used to reduce the number of lookup table rows for the correlations between two SF2 codes or correlations between one SF4 code and one SF2 code.

The inventors further observed that the correlations for (S_{4,1}ⁿ*S_{4,1}^{m})(t)=(S_{4,1}^{m}*S_{4,1}ⁿ)*(−t), where m≠n are stored twice in such a table according to example technique A. Accordingly, the amount of memory needed for correlation storage may be reduced by almost half. There are 2⁶*(2⁶−1)/2=2016 such rows. So all correlations where m>n can be removed from the table, and the resulting table has 2⁶*(2⁶+1)/2=2080 rows, and the size is 2080*32 bits=8320 bytes<8.2 kbytes (1 kbyte=1024 bytes). This table structure is referred to as example technique C and may be realized by storing the correlations as an upper-packed table/matrix where the upper triangular part, including the diagonal, is stored column by column. However, indexing or addressing such a table may be somewhat more complicated.

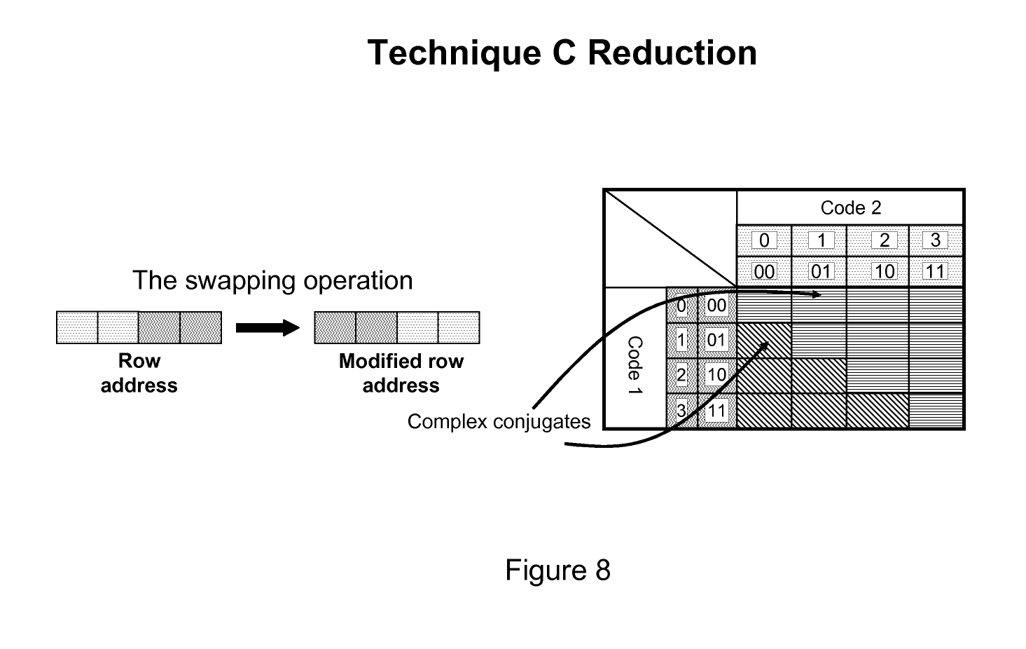

FIG. 8 shows this third technique for reducing a number of bits to be stored in a lookup table in accordance with the non-limiting example technique C. Techniques A, B, and C may be used alone or in any combinations. Like techniques A and B, technique C employs an “excluding similarities” approach. As observed in technique B in combination with technique A, Code 1 is fully determined by the second and third bits, and Code 2 is fully determined by the second and third bits. So there are four possibilities for Code 1 and four possibilities for Code 2 resulting in a lookup table with 16 rows as shown in FIG. 7. Looking for similarities between the rows, the inventors swapped the values of Code 1 and Code 2, and discovered that the value of the correlation between them is the same except for a complex conjugation. As a result, they determined that all 16 values need not be stored in the lookup table. For example, all values in the lower triangle (diagonal lines) are the complex conjugates of all the values in the upper triangle (horizontal lines). So the lookup table really only needs to store 10 correlation values (the upper triangle of horizontal lines) or a simpler representation that is used to invoke a correlation mapper. A simpler representation means storing addresses (instead of correlation values) and using these addresses to look into another table that contains those 10 correlation values. If the decimal representation of the first two bits of the row address (shown as dotted background) is greater than or equal to that of the last two bits (shown as vertical swiggly line background), then that decimal representation is used to compute an address (using equation (2) set forth below) to read one of the lookup table entries (the upper triangle of horizontal lines). If the decimal representation of the first two bits of the row address is less than that of the last two bits, that points to the lower triangle of diagonal lines. In this case, the first two bits are swapped with the last two bits, as shown, and decimal representations of the resulting bits are used to read one of the lookup table entries, where also the time lag −t is used to find the correct correlation value in the entry instead of the time lag t. A complex conjugate of the read value is taken to obtain the required correlation value. Technique C is preferably performed before the last anchor bit multiplication of technique B described above. Ultimately, the cumulative effect of using techniques A, B, and C reduces the lookup table size to 10/256 or just 3.9% of the original table size. Thus, these examples have shown that the storage savings with any and all of the above techniques is profound.

Example Addressing of a SF4×SF4 Table.

Recall that the value of the spreading code S_{4,1}ⁿ is completely determined by channelization code C_{ch,4,1} and the 6 bits c_{long,1,l}(n), c_{long,1,l}(n+1), c_{long,1,l}(n+2), c_{long,1,l}(n+3), c_{long,2,l}(n) and c_{long,2,l}(n+2) of the 8 scrambling generation bits. To identify the correct row in a lookup table for a particular spreading code correlation, the following example may be used:

aₘ=decimal value of the 6 of the 8 scrambling generation bits for S_{4,1}^{m}.

aₙ=decimal value of the 6 of the 8 scrambling generation bits for S_{4,1}ⁿ.

The address into the table of technique A would be

row=aₘ±aₙ2⁶ (2)

The address into the table of technique C would be

row=aₘ+aₙ(aₙ+1)/2 (3)

if aₙ≧aₘ. If aₙ<aₘ, the relation (S_{4,1}ⁿ*S_{4,1}^{m})(t)=(S_{4,1}^{m}*S_{4,1}ⁿ)*(−t) would be utilized by exchanging aₘ and aₙ and using these exchanged values to compute the address and by using the time lag −t instead of t to find the correlation value. The complex conjugate of the value found using the look-up table would then be used as the correlation value.

The rows in the example technique C table correspond to the address bit values aₘ and aₙ as illustrated in Table 1 below.

TABLE 1
Illustration of how the address bit values aₘ and aₙ map to table
row numbers in technique C tables.

| row | aₘ | aₙ |
|---|---|---|
| 0 | 0 | 0 |
| 1 | 0 | 1 |
| 2 | 1 | 1 |
| 3 | 0 | 2 |
| 4 | 1 | 2 |
| 5 | 2 | 2 |

Etc.

For example technique B, the correct row in the lookup table may be located using the following example:
aₘ=decimal value of the 5 bits sequence for S_{4,1}^{m}, (c_{long,1,l}(m)c_{long,1,l}(m+1), c_{long,1,l}(m)c_{long,1,l}(M+2), c_{long,1,l}(m)c_{long,1,l}(m+3), c_{long,1,l}(m)c_{long,2,l}(m), c_{long,1,l}(m)c_{long,2,l}(m+2))
aₙ=decimal value of the 5 bits sequence for S_{4,1}ⁿ, (c_{long,1,l}(n)c_{long,1,l}(n+1), c_{long,1,l}(n)c_{long,1,l}(n+2), c_{long,1,l}(n)c_{long,1,l}(n+3), c_{long,1,l}(n)c_{long,2,l}(n), c_{long,1,l}(n)c_{long,2,l}(n+2))
   The address into the table of technique A would be row=aₘ+aₙ2⁵. As described earlier, the correlation values read out from the table will need to be multiplied by the product of c_{long,1,l}(m) c_{long,1,l}(n).

Furthermore, example technique B can be combined with example technique C to achieve further reduction in the number of rows. With such a combination, the number of rows needed is only 2⁵*(2⁵+1)/2=528.

In any of the example SF4×SF4 table realizations, each row takes 32 bits, so the variable “row” simply needs a left-shift of 5 bit positions to formulate the address to the 32 bits that contain the desired correlation.

Number of Tables.

By examining the correlation expressions and understanding that the 6 of the 8 scrambling generation bits completely determine the spreading code (together with the channelization code), the correlation of all two SF2 codes can be looked up in only one SF2×SF2 table. Similarly, only one SF4×SF2 table is needed to store all correlations of S_{4,1}^{m} with any of the SF2 codes and only one SF4×SF4 table is needed for the correlation of S_{4,1}^{m} with S_{4,1}ⁿ.

Assuming technique C is used in combination with technique A, the total memory required for storage of the lookup tables is:

SF2×SF2: 64 rows of 8 bits: 64 bytes

SF4×SF2: 512 rows of 16 bits: 8192 bits=1 kbyte

SF4×SF4: 2080 rows of 32 bits=8320 bytes<8.2 kbytes

In a receiver that employs interference cancellation, the control channels can be cancelled before joint detection. However, if control channels are also handled by the joint detection algorithm and the code correlations for the control channel spreading codes are needed, two additional tables for SF4×SF4 are preferably employed: one for S_{4,0}^{m} correlated with S_{4,0}ⁿ and one for S_{4,0}^{m} correlated with S_{4,1}ⁿ. Also another SF4×SF2 table is preferably employed for correlations of S_{4,0}^{m} with the SF2 codes.

Only Intra-Block Code Correlations.

If only symbols within one symbol block are jointly detected, only the correlations between the three data spreading codes S_{4,1}ⁿ, S_{2,1}ⁿ and S_{2,1}ⁿ⁺² within one 4-chip symbol block are required, e.g., by a joint detection algorithm, a small lookup table can be used. Since S_{4,1}ⁿ, S_{2,1}ⁿ, and S_{2,1}ⁿ⁺² are orthogonal at zero lag correlation, those correlation values do not need storage. Furthermore, the autocorrelations are Hermitian functions, and as a result, only the autocorrelations for positive lags need to be stored because the autocorrelations at negative lags are simply the complex conjugates of the positive lag autocorrelation values. As in the more general case of inter-block correlations described above, separate tables may be used for the SF4×SF4, SF4×SF2 and SF2×SF2 cases. However, the final table in the intra-block correlation case may be so small that these optimizations, although they may be used, may not be justified. Instead, only one lookup table for all correlation values is described.

The realization of the three spreading codes S_{4,1}ⁿ, S_{2,1}ⁿ and S_{2,1}ⁿ⁺² in a 4-chip symbol block is determined by 6 of the 8 scrambling generation bits. So the final lookup table will have 2⁶=64 rows. The autocorrelation (S_{4,1}ⁿ*S_{4,1}ⁿ)(t) needs storage of 3 correlations which take 4, 9, and 16 unique values. (S_{2,1}ⁿ*S_{2,1}ⁿ)(t) and (S_{2,1}ⁿ⁺²*S_{2,1}ⁿ⁺²)(t) each have only one correlation value to store, and that correlation can take 4 unique values. The cross-correlations (S_{4,1}ⁿ*S_{2,1}ⁿ)(t) and (S_{4,1}ⁿ*S_{2,1}ⁿ⁺²)(t) need storage of 4 correlations, which take 4, 9, 9, and 4 unique values. (S_{2,1}ⁿ*S_{2,1}ⁿ⁺²)(t) needs storage of 3 correlations, which take 4, 9, and 4 unique values.

Since the final table is quite small, 4 bits may be used to store each correlation value, even though fewer bits can be used to represent the unique values of the correlations at some lags. So each row in the table stores 16 correlations, with 4 bits each. If the table has 64 rows, then the final table size is 512 bytes.

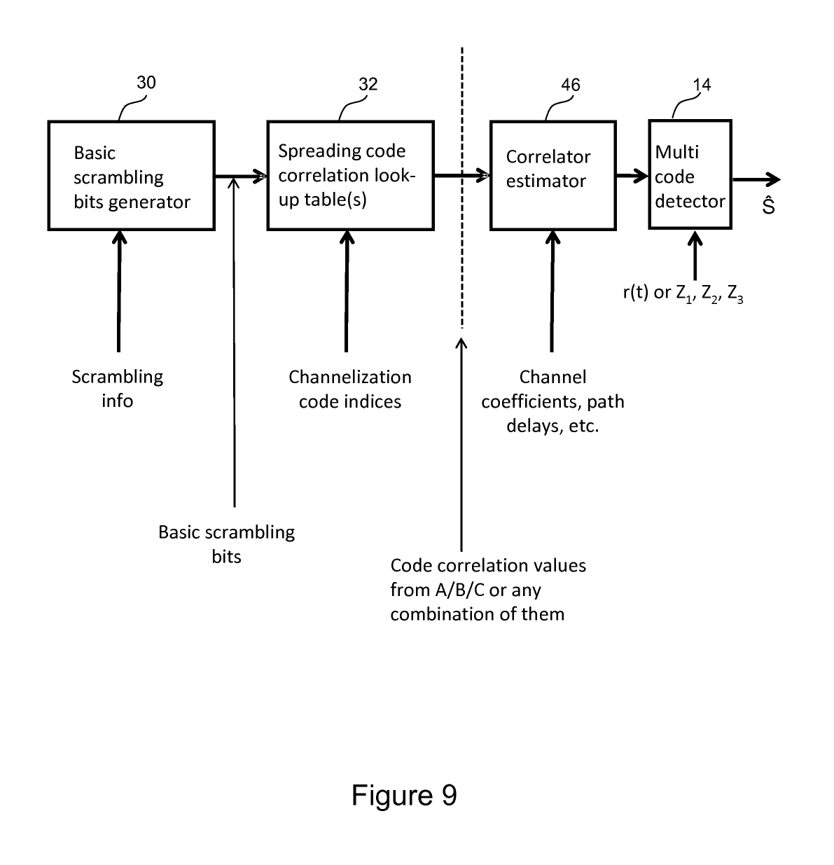

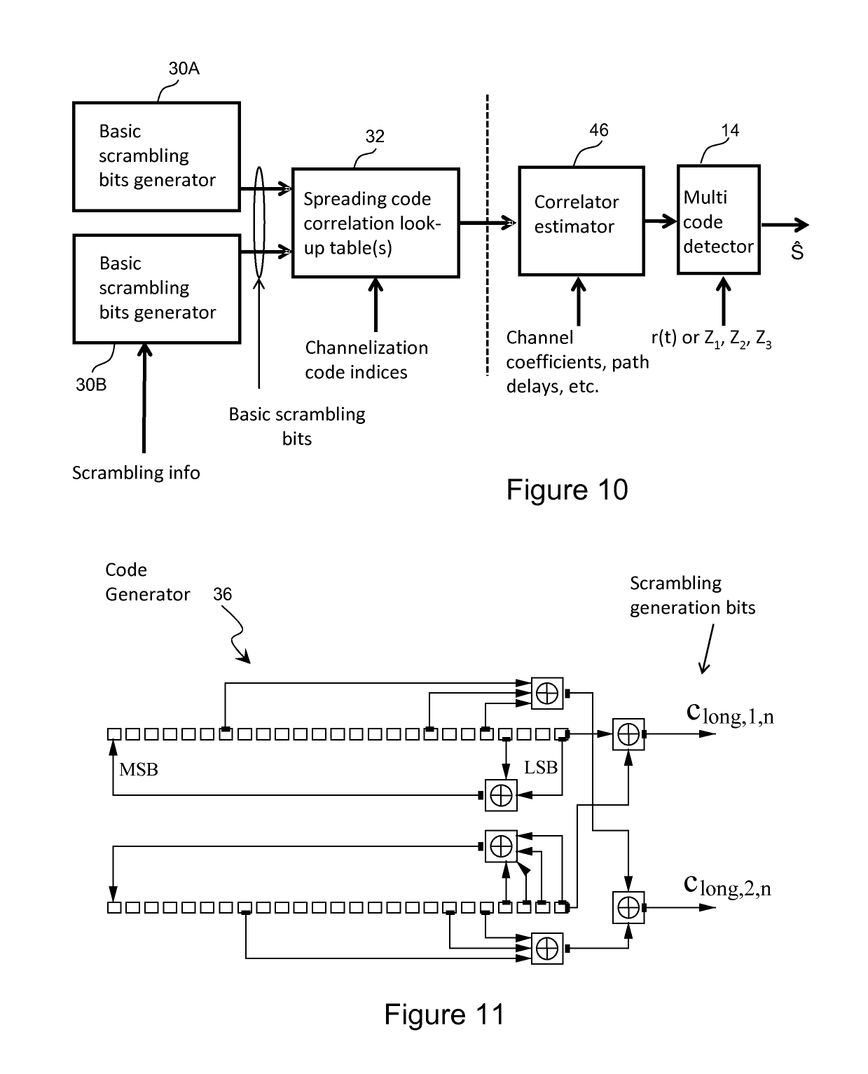

FIG. 9 is a portion of a radio receiver that provides spreading sequence correlations in accordance with a non-limiting example embodiment in which the technology described in this application may be employed. A basic scrambling bitsgenerator 30 receives scrambling information, e.g., a scrambling code number, and generates the basic scrambling bits, in form of either scrambling generation bits or scrambling sequence, in accordance with equation (1) above. These basic scrambling bits are used to formulate an address to one or more spreading sequence correlation lookup tables 32, which also uses channelization code indices to provide the desired spreading sequence correlation value. Channelization code indices are used to select which table to address. The retrieved spreading sequence correlation value(s) is/are used by a correlation estimator 46 along with estimated channel coefficients, path delays, and perhaps other information to determine combining weights. A multicode detector 14 uses the combining weights in determining the modulation values for each of the jointly detected symbols in the one or more symbol blocks. FIG. 10 is a portion of a radio receiver that provides spreading sequence correlations in accordance with another non-limiting example embodiment. Here, the basic scrambling bits are generated by two basic scrambling bits generators 30A and 30B (see the discussion above for two symbol blocks in FIG. 4 and for intra-block code correlations and FIG. 9).

FIG. 11 is a non-limiting example of an uplink long scrambling sequence generator 36 that may be used to generate two component sequences c_{long,1,n} and c_{long,2,n}. These scrambling generation bits are used to generate the complex-valued, uplink long scrambling sequence according to equation (1) above. The generator 36 includes two parallel shift registers with various bits being tapped as inputs to exclusive-OR operations as shown.

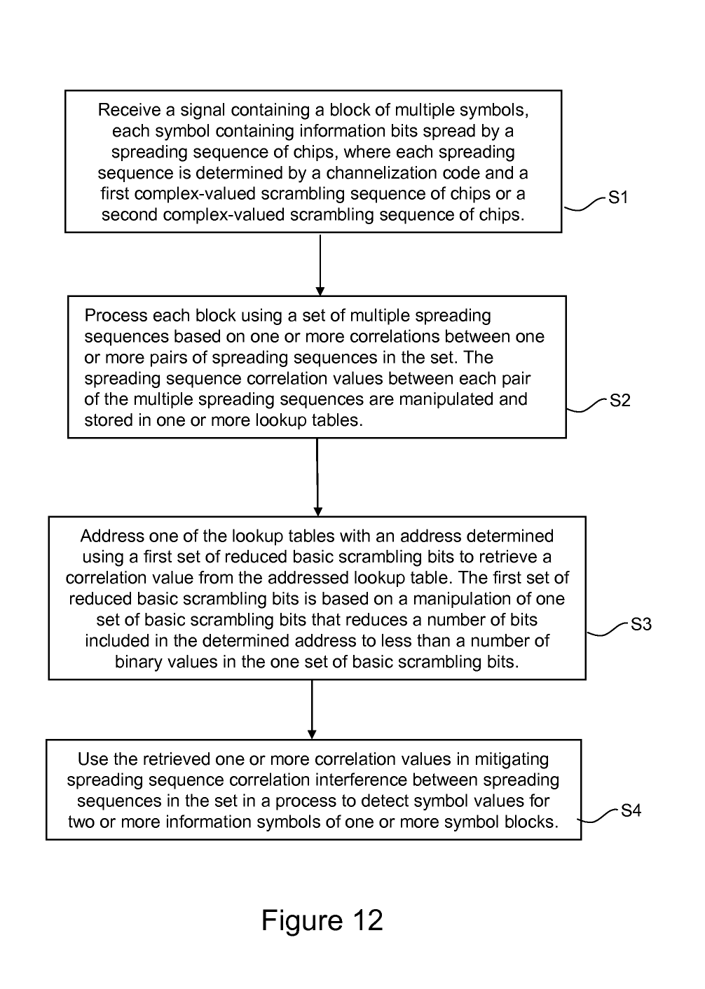

FIG. 12 is a flowchart of non-limiting example procedures for generating and using correlation values for a signal received containing a symbol block of multiple symbols, each symbol containing information bits spread by a spreading sequence of chips (step S1). Each spreading sequence is determined by a channelization sequence and a first complex-valued scrambling sequence of chips or a second complex-valued scrambling sequence of chips. Each symbol block is processed using a set of multiple spreading sequences using one or more correlations between one or more pairs of spreading sequences in the set (step S2). Spreading sequence correlation values between each pair of the multiple spreading sequences in the set are stored in one or more lookup tables. One of the lookup tables is addressed with an address determined using a first set of reduced basic scrambling bits to retrieve one or more correlation values from the addressed lookup table (step S3). The first set of reduced basic scrambling bits is based on manipulation of one set of basic scrambling bits that reduces a number of bits included in the determined address to less than a number of binary values in the one set of basic scrambling bits. The one set of basic scrambling bits is based on either the scrambling sequences or on the scrambling generation bits. As described above, for an example 4-chip long QPSK scrambling sequence with 8 binary values, example technique A reduces the 8 bits to 6 bits. Manipulations for example techniques B and C to achieve further reductions were described above. The retrieved one or more correlation values is then used in mitigating spreading sequence correlation interference between spreading sequences in the set in a process to detect symbol values for two or more information symbols in one or more symbol blocks (step S4).

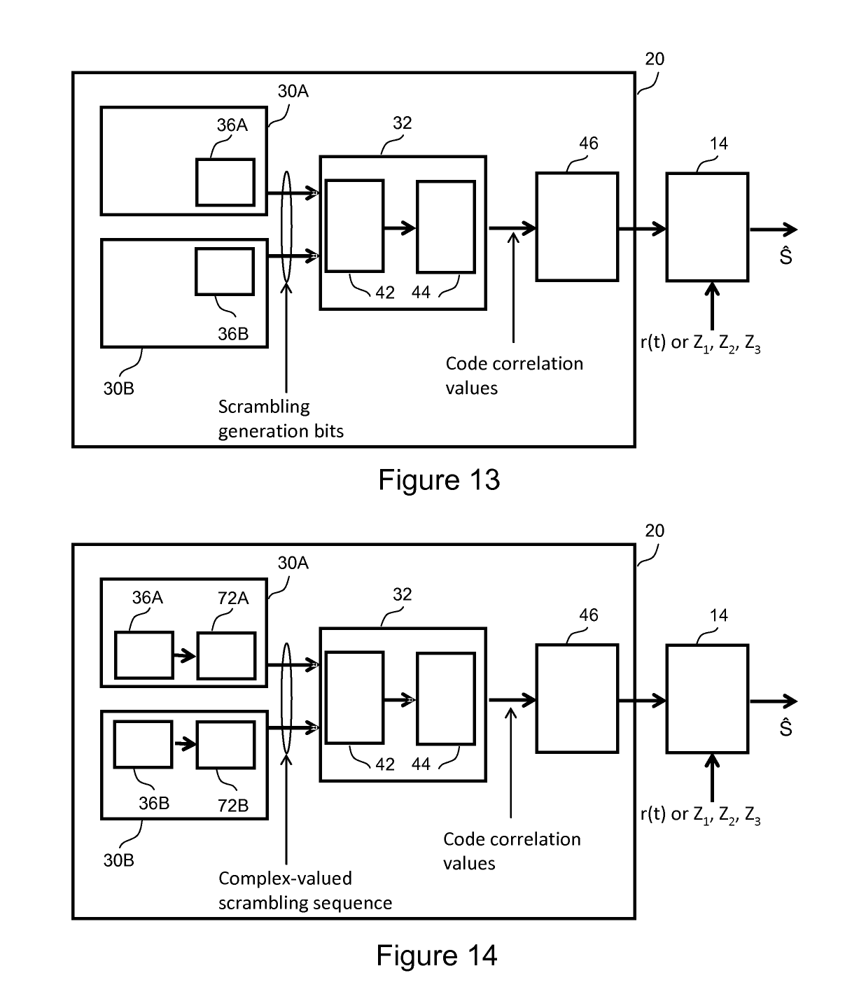

FIG. 13 is a function block diagram of a Rake processor 20 that may be used for example in the radio receiver of FIG. 2 to generate combining weights for the multicode detector 14 in accordance with a non-limiting example embodiment. Scrambling sequence generators 36A and 36B (FIG. 11 shows one non-limiting example) in respective basic scrambling bits generators 30A and 30B provide a first set and a second set of scrambling generation bits to an address generator 42. The address generator 42 applies technique A, technique B, or technique C or any combination of these techniques to these sets of scrambling generation bits to generate an address to access a desired spreading sequence correlation value stored in one or more lookup tables 44.

FIG. 14 is similar to FIG. 13 with additional sequence generators 72A and 72B in 30A and 30B respectively to use a first set and a second set of scrambling generation bits to generate first and second binary-valued scrambling sequences which are used as input to the address generator 42. The address generator 42 applies technique A, technique B, or technique C or any combination of these techniques to these scrambling sequences to generate an address to access a desired spreading sequence correlation value stored in one or more lookup tables 44.

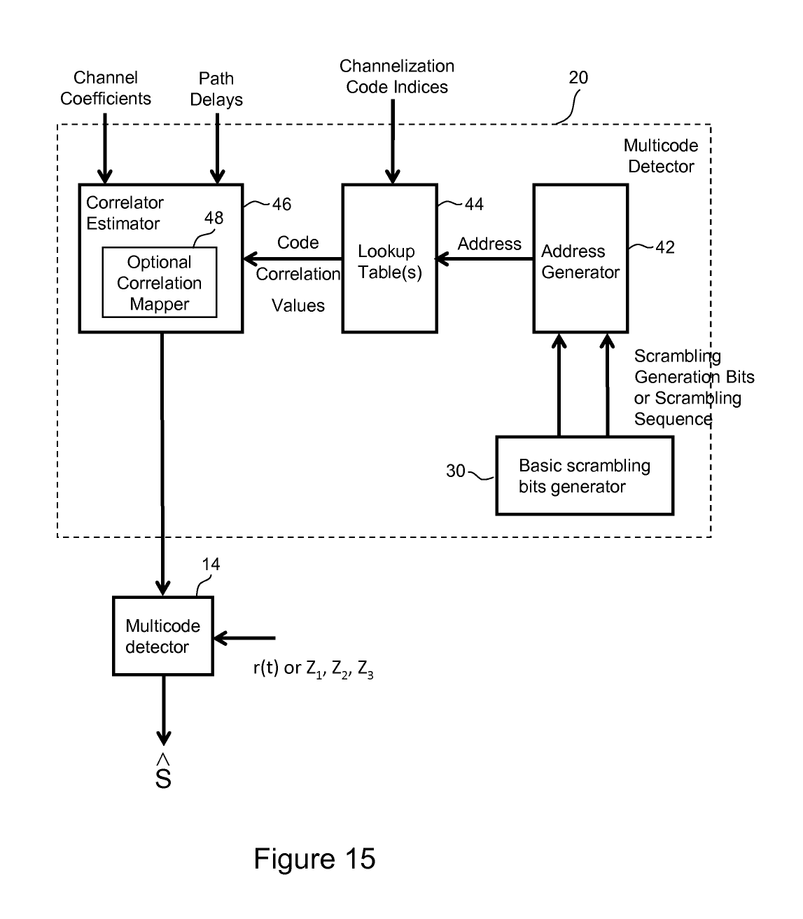

FIG. 15 is a function block diagram of a multicode detector 14 that may be used for example in the radio receiver of FIG. 2 in accordance with a non-limiting example embodiment. Although separate blocks are shown for purposes of illustration, one, multiple ones, or all of these blocks may be implemented using dedicated and/or suitably programmed/configured general purpose data processing circuitry. A basic scrambling bits generator 30 (FIG. 13 and FIG. 14 show two non-limiting examples) provides first and second binary-valued scrambling sequences, or first set and second set of scrambling generation bits, to the address generator 42 to generate an address to access a desired spreading sequence correlation value stored in one or more lookup tables 44. Channelization code indices are used to select the lookup table to be addressed. The accessed spreading sequence correlation value is processed by a symbol waveform correlation estimator 46 along with channel coefficients and path delays to compute for example an effective spreading waveform correlation matrix R. If the correlation value received from the lookup table is not the actual spreading sequence correlation, then one or more optional correlation mappers 48 may be used in the correlator estimator 46 to map the received correlation value to an actual spreading sequence correlation. A multicode detector 14 estimates the symbols based on symbol waveform correlations.

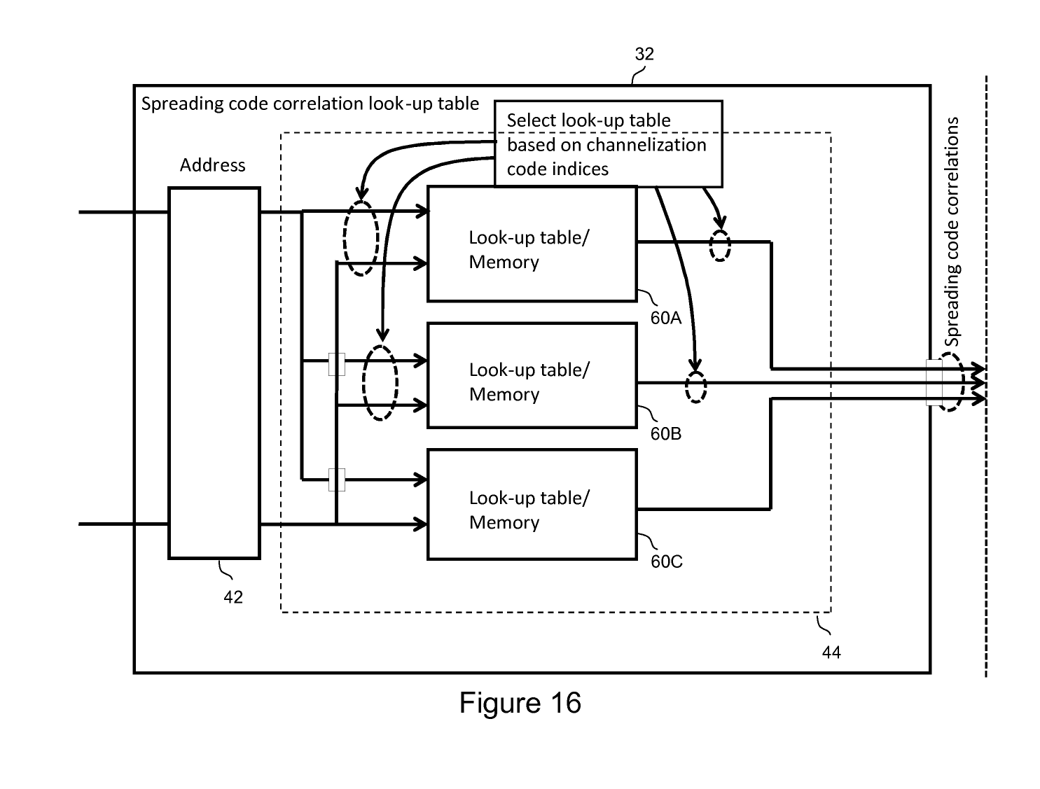

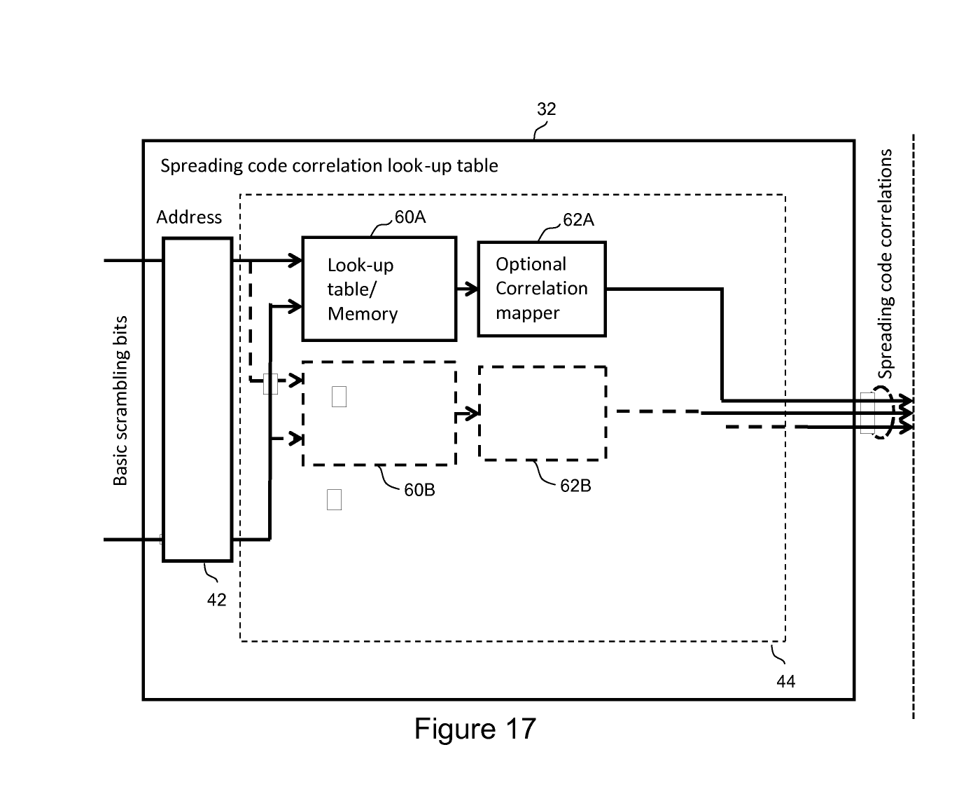

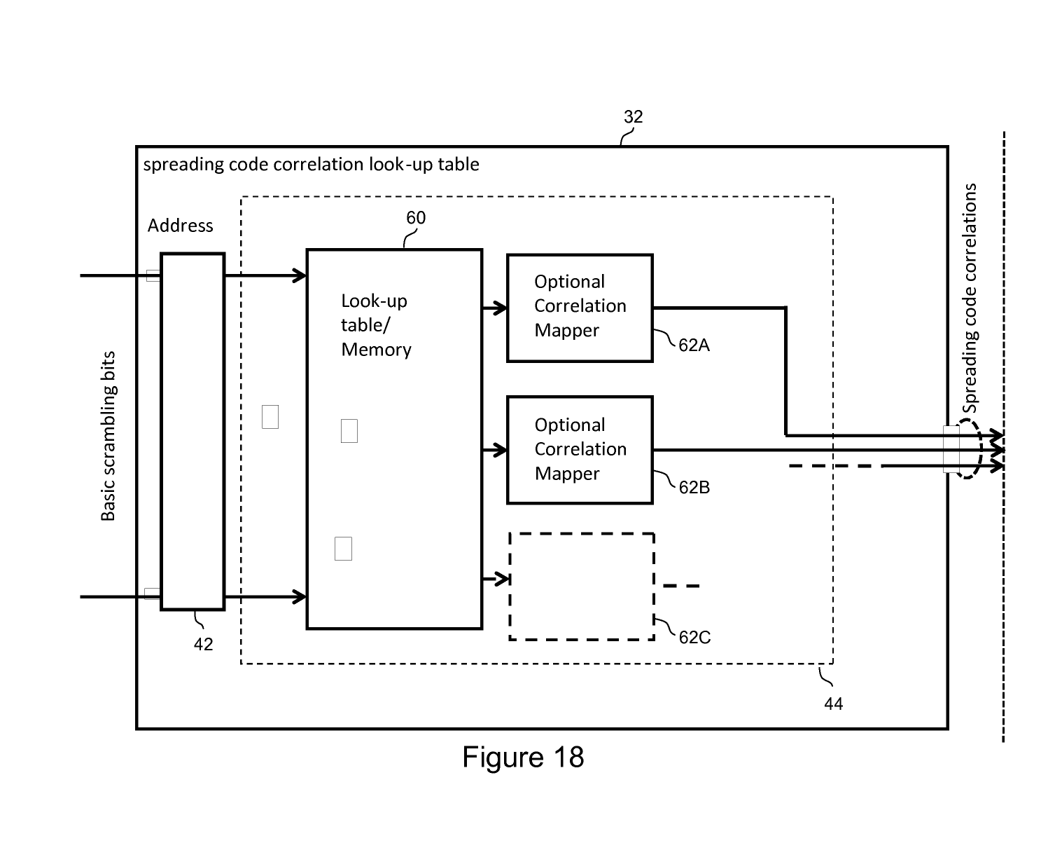

FIG. 16 shows a non-limiting example embodiment that uses multiple spreading sequence correlation lookup tables 60A, 60B, and 60C. FIG. 17 shows a non-limiting example embodiment that uses multiple spreading sequence correlation lookup tables 60A and 60B and corresponding optional correlation mappers 62A and 62B. FIG. 18 shows a non-limiting example embodiment with one spreading sequence correlation lookup table 60 and multiple optional correlation mappers 62A-62C.

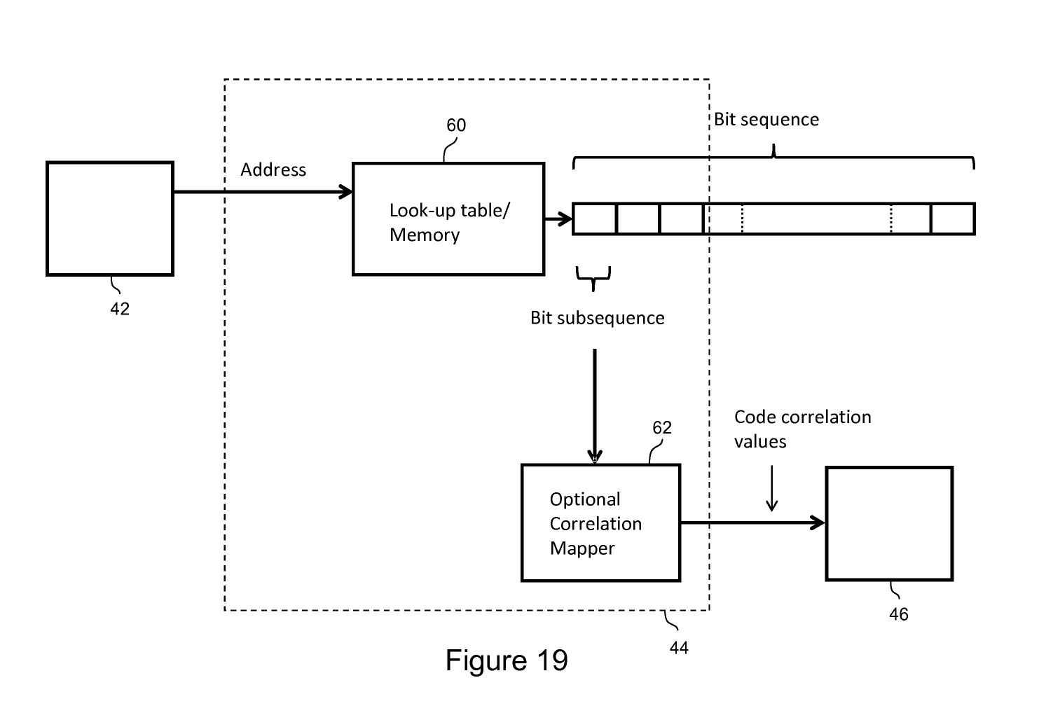

FIG. 19 shows a non-limiting example of a spreading sequence correlation lookup table 60 output used by one or more optional correlation mappers 62. The address determined using one example technique applied to the basic scrambling bits (scrambling generation bits or scrambling sequence) chooses the appropriate row in the lookup table. In that row, a sequence of bits is accessed. Subsequences of this bit sequence correspond to different spreading code correlations and/or correlation lags, for example, the first 2 bits might correspond to the correlation of S_{4,1}^{m} and S_{4,1}ⁿ at lag −3, that is, (S_{4,1}^{m}*S_{4,1}ⁿ)(−3), while the subsequent 4 bits correspond to the correlation of the same spreading codes but at lag −2, that is, (S_{4,1}^{m}*S_{4,1}ⁿ)(−2). Different correlation mappers may be used to obtain the actual correlation values. One example mapper might map 2 bits to correlation coefficient values {+2, +2j, −2, −2j}, while another mapper maps 4 bits to correlation coefficient values {0, +2+2j, +2−2j, −2+2j, 2−2j, +4, +4j, −4, −4j}.

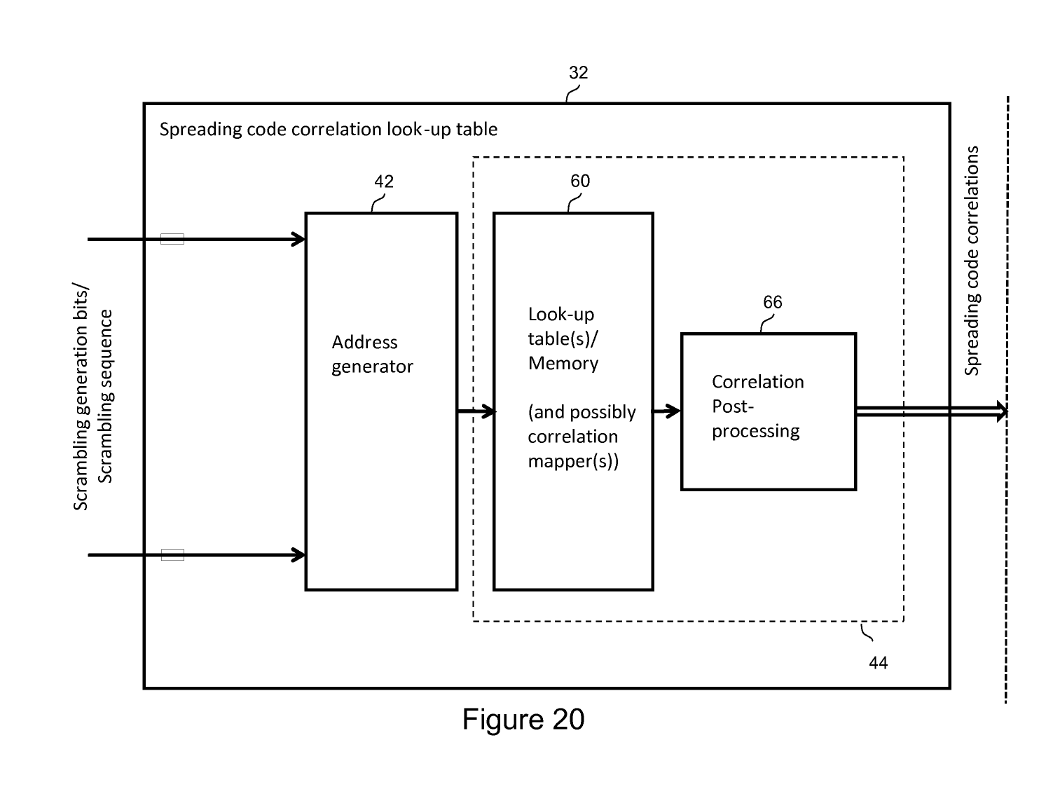

FIG. 20 shows a non-limiting example embodiment with a spreading sequence correlation lookup table 60 with correlation post-processing 66 that may be used to implement example technique A or C described above which reduces the lookup table storage requirements. If, for example, technique C is used, the address generator 42 can form aₙ and aₘ as described above, examine whether aₙ≧aₘ or aₙ<aₘ, and in the latter case, exchange values of aₙ and aₘ when computing the row address and changing the sign of the time lag t to −t when determining which correlation value to access in the sequence of bits found at the row address as described above. The post-processing 66 then examines the original aₙ and aₘ, and if aₙ<aₘ, then the post-processing 66 post-processes the value received from 60 by taking the complex conjugate of that value and using the result as spreading code correlation.

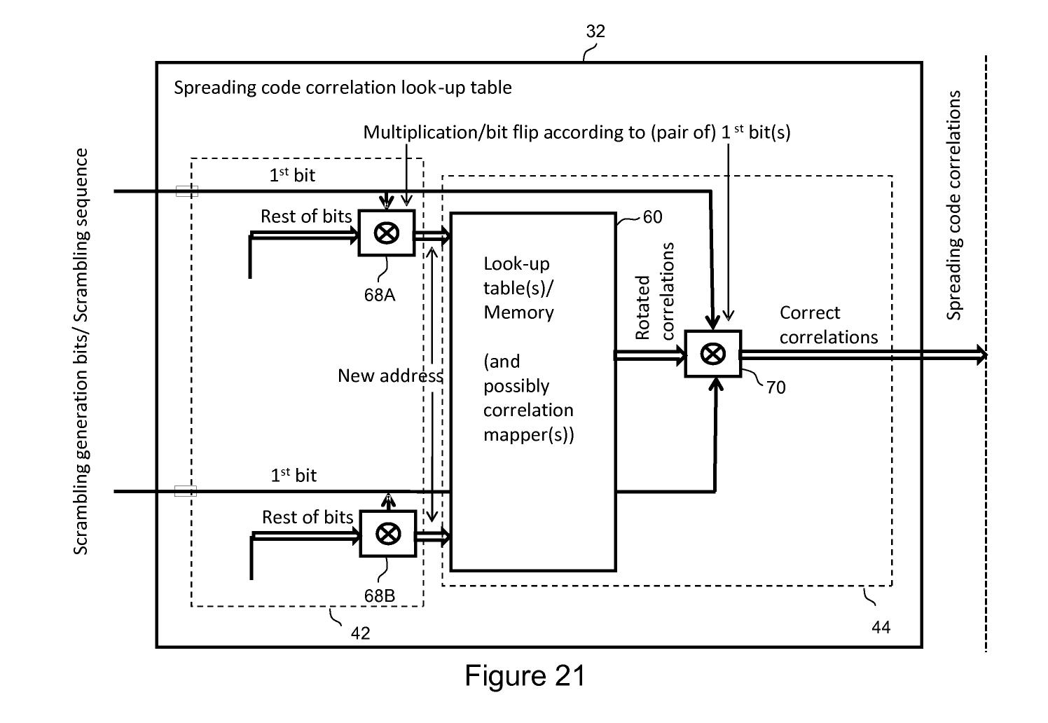

FIG. 21 shows another non-limiting example embodiment of a spreading sequence correlation lookup table that may be used to implement example technique B described above. Address pre-processing at multipliers/bit flippers 68A, 68B and correlation post-processing at multipliers/bit flipper 70 reduces the required storage space of the lookup table(s). For example, the first bit c_{long,1,l}(m) is removed from the sequence of reduced basic scrambling bits c_{long,1,l}(m), c_{long,1,l}(m+1), c_{long,1,l}(m+2), c_{long,1,l}(m+3), c_{long,2,l}(m), c_{long,2,l}(m+2), and in multiplier/bit flipper 68A, the first bit c_{long,1,l}(m) is multiplied with the rest of these reduced basic scrambling bits c_{long,1,l}(m+1), c_{long,1,l}(m+2), c_{long,1,l}(m+3), c_{long,2,l}(m), c_{long,2,l}(M+2) to obtain the bit sequence c_{long,1,l}(m)c_{long,1,l}(m+1), c_{long,1,l}(m)c_{long,1,l}(m+2), c_{long,1,l}(m)c_{long,1,l}(m+3), c_{long,1,l}(m)c_{long,2,l}(m), c_{long,1,l}(m)c_{long,2,l}(m+2). A corresponding procedure is used in multiplier/bit flipper 68B but with the bit sequence c_{long,1,l}(n), c_{long,1,l}(n+1), c_{long,1,l}(n+2), c_{long,1,l}(n+3), c_{long,2,l}(n), c_{long,2,l}(n+2) to obtain the bit sequence c_{long,1,l}(n)c_{long,1,l}(n+1), c_{long,1,l}(n)c_{long,1,l}(n+2), c_{long,1,l}(n)c_{long,1,l}(n+3), c_{long,1,l}(n)c_{long,2,l}(n), c_{long,1,l}(n)c_{long,2,l}(n+2). The bit sequences obtained from multipliers/bit flippers 68A and 68B are used as an address in the look-up table(s). The multiplication in multipliers/bit flippers 68A and 68B can be realized as bit flips where the input bits denoted “rest of bits” are flipped, that is, changed to the opposite value, if the bit denoted “1^{st} bit” has a value of −1. The output of the look-up table(s) denoted “rotated correlations” is multiplied by c_{long,1,l}(m)c_{long,1,l}(n) in 70, or if realized as bit flips, the sign of the real and imaginary values of the correlation values denoted “rotated correlations” is changed if c_{long,1,l}(m)c_{long,1,l}(n) has the value −1.

Although the non-limiting examples above are given for a single peak rate user, the code correlations computed in the tables may also be used for joint detection of multiple users or for symbol-level IC of multiple users. The non-limiting examples use 4-chip blocks, but spreading code correlations for symbol blocks of larger size may be obtained by post-processing (summing) the correct values from the tables. The same lookup tables may be used in a variety of applications. One example is in maximum likelihood sequence estimation (MLSE) used as a last step in multi-stage group detection (MSGD), also known as assisted maximum likelihood detection, (AMLD).

The technology described above uses the structure of the scrambling code together with pre-computed lookup tables to quickly obtain correlations between the spreading codes. The technology is relatively computationally inexpensive and requires only a small memory compared to pre-computing and storing all possible correlations.

Although the description above contains many specifics, these should not be construed as limiting the scope of the claims but as merely providing illustrations of example embodiments. It will be appreciated that the technology claimed fully encompasses other embodiments which may become apparent to those skilled in the art, and that the scope of the claims is accordingly not to be limited. Reference to an element in the singular is not intended to mean “one and only one” unless explicitly so stated, but rather “one or more.” All structural and functional equivalents to the elements of the above-described embodiments that are known to those of ordinary skill in the art are expressly incorporated herein by reference and are intended to be encompassed hereby. Moreover, it is not necessary for a device or method to address each and every problem sought to be solved for it to be encompassed hereby. No element, block, or instruction used in the present application should be construed as critical or essential to the implementations described herein unless explicitly described as such. Further, the phrase “based on” is intended to mean “based, at least in part, on” unless explicitly stated otherwise. Unclaimed subject matter is not dedicated to the public and Applicant reserves all rights in unclaimed subject matter including the right to claim such subject matter in this and other applications, e.g., continuations, continuations in part, divisions, etc.

1. A method in a receiver, comprising:
receiving a signal containing a block of multiple symbols, each symbol containing information bits spread by a spreading sequence of chips, where each spreading sequence is determined by a channelization sequence and a first complex-valued scrambling sequence of chips or a second complex-valued scrambling sequence of chips;
processing each symbol block using a set of multiple spreading sequences using one or more correlations between one or more pairs of spreading sequences in the set, wherein spreading sequence correlation values between each pair of the multiple spreading sequences in the set are manipulated and stored in one or more lookup tables;
addressing one of the lookup tables with an address determined using a first set of reduced basic scrambling bits to retrieve one or more correlation values from the addressed lookup table, wherein the first set of reduced basic scrambling bits is based on manipulation of one set of basic scrambling bits which reduces a number of bits included in the determined address to less than a number of binary values in the one set of basic scrambling bits, wherein the one set of basic scrambling bits is used to construct one of the first and second complex-valued scrambling sequences; and
using the retrieved one or more correlation values in mitigating spreading sequence correlation interference between spreading sequences in the set in a process to detect symbol values for two or more information symbols in the symbol block.

2. The method in claim 1, wherein manipulation of the one set of basic scrambling bits includes exploiting one or more redundancies of the one set of basic scrambling bits.

3. The method in claim 2, wherein the manipulation includes eliminating at least one bit in the one set of basic scrambling bits for addressing the one lookup table based on a redundant bit value in the one set of basic scrambling bits.

4. The method in claim 2, wherein the manipulation includes storing only a correlation value for two different correlations between each pair of the multiple spreading sequences.

5. The method in claim 4, wherein the first set of address bits represents a number that is smaller than or equal to the number represented by the second set of address bits.

6. The method of claim 4, wherein the first set of address bits represents a number that is greater than the number represented by the second set of address bits, exchanging values of the first and the second sets address bits to compute the address value, and changing the sign of the time lag to find the address in one of the lookup tables.

7. The method in claim 2, wherein the manipulation includes storing entries in the lookup table only where a first bit in each of two of the first set of scrambling generation bits is equal to 0 in a 0/1 representation of binary bits.

8. The method in claim 7, wherein the address bits used to access the lookup table do not contain the first bit.

9. The method in claim 1, wherein each complex-valued scrambling sequence is determined by a first binary-valued scrambling sequence that determines a real part of the complex-valued scrambling sequence and a second binary-valued scrambling sequence that determines an imaginary part of the complex-valued scrambling sequence.

10. The method in claim 9, further comprising:
generating the first and second binary-valued scrambling sequences for the first complex-valued scrambling sequence, and
determining the first set of the reduced basic scrambling bits based on the first and second binary-valued scrambling sequences for the first complex-valued scrambling sequence.

11. The method in claim 10, wherein the address includes a first set of address bits and a second set of address bits, the method further comprising:
generating the first and second binary-valued scrambling sequences for the second complex-valued scrambling sequence;
determining a second set of reduced basic scrambling bits based on the first and second binary-valued scrambling sequences for the second complex-valued scrambling sequence; and
determining the second set of address bits based on the second set of the reduced basic scrambling bits,
wherein the one lookup table is addressed with an address determined using the first set of address bits and the second set of address bits to retrieve a first set of correlation values associated with the spreading sequences of the two or more information symbols.

12. The method in claim 11, further comprising:
mapping the first set of correlation values to an actual correlation value.

13. The method in claim 11, wherein determining the first set of address bits includes performing an exclusive-OR (XOR) product operation with an anchor bit among the first set of the reduced basic scrambling bits and with each of the other bits among the first set of the reduced basic scrambling bits, and forming the first set of address bits based on the XOR products.

14. The method of claim 1, wherein the complex-valued scrambling sequence is defined by:
C_{long,n}(i)=c_{long,1,n}(i)(1+j(−1)ⁱc_{long,2,n}(2└i/2┘))
wherein:
i is a chip index starting at 0,
the block is a 4-chip symbol block,
the binary values of the scrambling sequence are eight binary values based on the binary values c_{long,1,n}(0), c_{long,2,n} (0), c_{long,1,n}(1), c_{long,2,n}(1), c_{long,1,n} (2), c_{long,2,n}(2), c_{long,1,n}(3), c_{long,2,n}(3) and correspond to the one set of basic scrambling bits, and
c_{long,1,n}(0), c_{long,2,n} (0), c_{long,1,n}(1), c_{long,1,n} (2), c_{long,2,n}(2), c_{long,1,n}(3) correspond to the reduced basic scrambling bits.

15. An apparatus for a receiver, comprising:
a receiver configured to receive a signal containing a block of multiple symbols, each symbol containing information bits spread by a spreading sequence of chips, where each spreading sequence is determined by a channelization sequence and a first complex-valued scrambling sequence of chips or a second complex-valued scrambling sequence of chips;
correlation circuitry configured to process each block using a set of multiple spreading sequences using one or more correlations between one or more pairs of spreading sequences in the set, wherein spreading sequence correlation values between each pair of the multiple spreading sequences in the set are manipulated and stored in one or more lookup tables;
an address generator configured to address one of the lookup tables with an address determined using a first set of reduced basic scrambling bits to retrieve one or more correlation values from the addressed lookup table, wherein the first set of reduced basic scrambling bits is used to construct one of the first and second complex-valued scrambling sequences and is based on manipulation of the one set of basic scrambling bits which reduces a number of bits included in the determined address to less than a number of binary values in the one set of basic scrambling bits; and
symbol estimation circuitry configured to use the retrieved one or more correlation values in mitigating spreading sequence correlation interference between spreading sequences in the set in a process to detect symbol values for two or more information symbols in the received block.

16. The apparatus in claim 15, wherein manipulation of the one scrambling sequence includes exploiting one or more redundancies of the one scrambling sequence.

17. The apparatus in claim 16, wherein the manipulation includes eliminating at least one bit in the one scrambling sequence for addressing the one lookup table based on a redundant bit value in the one scrambling sequence.

18. The apparatus in claim 16, wherein the manipulation includes storing only a correlation value for two different correlations between each pair of the multiple spreading sequences.

19. The apparatus in claim 18, wherein the first set of address bits represents a number that is smaller than or equal to the number represented by the second set of address bits.

20. The apparatus of claim 18, wherein the first set of address bits represents a number that is greater than the number represented by the second set of address bits, exchanging values of the first and the second sets address bits to compute the address value, and changing the sign of the time lag to find the address in one of the lookup tables.

21. The apparatus in claim 16, wherein the manipulation includes storing entries in the lookup table only where a first bit in each of two of the first set of scrambling generation bits is equal to 0.

22. The apparatus in claim 15, wherein each complex-valued scrambling sequence is determined by a first binary-valued scrambling sequence that determines a real part of the complex-valued scrambling sequence and a second binary-valued scrambling sequence that determines an imaginary part of the complex-valued scrambling sequence.

23. The apparatus in claim 22, wherein the address bits used to access the lookup table do not contain the first bit.

24. The apparatus in claim 23, further comprising:
a code generator configured to generate the first and second binary-valued scrambling sequences for the first complex-valued scrambling sequence, and
a scrambling bits processor configured to determine the first set of the scrambling generation bits based on the first and second binary-valued scrambling sequences for the first complex-valued scrambling sequence.

25. The apparatus in claim 24, wherein the address includes a first set of address bits and a second set of address bits, the apparatus further comprising:
a code generator configured to generate the first and second binary-valued scrambling sequences for the second complex-valued scrambling sequence;
a scrambling bits processor configured to determine a second set of scrambling generation bits based on the first and second binary-valued scrambling sequences for the second complex-valued scrambling sequence;
determining the second set of address bits based on the second set of the scrambling generation bits; and
wherein the one lookup table is addressed with an address determined using the first set of address bits and the second set of address bits to retrieve a first set of correlation values associated with the spreading sequences of the two or more information symbols.

26. The apparatus in claim 25, further comprising:
mapping circuitry configured to map the first set of correlation values to an actual correlation value.

27. The apparatus in claim 25, wherein determining the first set of address bits includes performing an exclusive-OR (XOR) product operation with an anchor bit among the first set of the scrambling generation bits and with each of the other bits among the first set of the scrambling generation bits, and forming the first set of address bits based on the XOR products.

28. The apparatus of claim 15, wherein the complex-valued scrambling sequence is defined by:
C_{long,n}(i)=c_{long,1,n}(i)(1+j(−1)ⁱc_{long,2,n}(2└i/2┘))
wherein:
i is a chip index starting at 0,
the block is a 4-chip symbol block,
the binary values of the scrambling sequence are eight binary values based on the binary values c_{long,1,n}(0), c_{long,2,n} (0), c_{long,1,n}(1), c_{long,2,n}(1), c_{long,1,n} (2), c_{long,2,n}(2), c_{long,1,n}(3), c_{long,2,n}(3) and correspond to the one set of basic scrambling bits, and
c_{long,1,n}(0), c_{long,2,n} (0), c_{long,1,n}(1), c_{long,1,n} (2), c_{long,2,n}(2), c_{long,1,n}(3) correspond to the reduced basic scrambling bits.
